(19) United States
(12) Patent Application Publication
(10) Pub. No.: US 2025/0188328 A1
(43) Pub. Date: Jun. 12, 2025

(54) TWO-COMPONENT POLYURETHANE ADHESIVE COMPOSITION

(71) Applicant: DDP SPECIALTY ELECTRONIC MATERIALS US, LLC, Wilmington, DE (US)

(72) Inventors: Stefan SCHMATLOCH, FREIENBACH (CH); Gina-Gabriela BUMBU, FREIENBACH (CH); Ilona CADERAS, FREIENBACH (CH); Andreas LUTZ, FREIENBACH (CH)

(21) Appl. No.: 18/845,534

(22) PCT Filed: Apr. 5, 2023
(86) PCT No.: PCT/US2023/017512

§ 371 Date: Sep. 10, 2024

Related U.S. Application Data
(60) Provisional application No. 63/395,433, filed on Aug. 5, 2022.
(60) Provisional application No. 63/327,862, filed on Apr. 6, 2022.

(51) Int. Cl. C09J 175/08; C08G 18/12; C08G 18/32; C08G 18/48; C08G 18/66; C08K 3/04; C08K 3/22; C08K 7/24; C09J 9/00; C09J 11/04; C09K 5/14

(52) U.S. Cl. CPC C09J 175/08; C08G 18/12; C08G 18/3206; C08G 18/4829; C08G 18/6674; C09J 9/00; C09J 11/04; C09K 5/14; C08K 3/04; C08K 2003/2227; C08K 7/24; C08K 2201/001; C08K 2201/016

(57) ABSTRACT

Provided herein is a two-component polyurethane adhesive composition.

### CROSS-REFERENCE TO RELATED APPLICATIONS

This application claims priority to U.S. Provisional Application No. 63/327,862, filed Apr. 6, 2022, and U.S. Provisional Application No. 63/395,433, filed Aug. 5, 2022, both of which are incorporated into this application by reference.

### FIELD OF INVENTION

The present invention relates to the field of two-component polyurethane adhesive compositions.

### BACKGROUND OF THE INVENTION

The use of adhesive technology and adhesive bonding in modern vehicle design is growing. Adhesive joints are the most preferred assembly technology, as bonding retains the integrity of assembled parts (in contrast to mechanical fixation, such as e.g. screwing or riveting). Additionally, the continuous bond lines made possible with adhesives increase the performance of bonded parts and modules. Continuous bond lines provide torsion stiffness and high crash resistance of parts, modules, and entire car bodies.

Fast adhesive application processes and heat accelerated curing processes reduces tack times and accelerates assembly processes. These same advantages of adhesive bonding also apply to the assembly of battery modules for electric vehicles. Adhesive bonding provides the stringent crash and crunch performance requirements which are required for battery compartments. In addition to structural requirements, battery module and battery compartment designs need to fulfill thermal management requirements. Heat, which is generated during the operation of the battery needs to be transferred into the cooling units. This requires heat transfer between battery cells, battery modules or between the battery compartment and the cooling unit.

There are thermally conductive interface materials available in the market. There are also thermally conductive adhesives available for the electronic industry. Thermal conductivity is achieved predominantly using thermally conductive fillers. Application process, cure speed, strength, crash performance requirements, durability and exposure resistance of these materials however do not fulfill automotive industry requirements.

### SUMMARY OF THE INVENTION

In a first aspect, the invention provides a thermally-conductive, two-component polyurethane adhesive comprising:
(A) a first component (isocyanate component), comprising:
   (a1) at least one polyisocyanate;
(B) a second component (polyol component), comprising:
   (b1) at least one polyetherpolyol; and
   (b2) at least one catalyst capable of catalyzing the reaction of a hydroxyl group with an isocyanate group;
wherein Component A and/or Component B comprise (a2, b3) thermally conductive filler which comprises:
   (i) aluminium trihydroxide having a multimodal particle size distribution;
   (ii) expandable graphite, and
   (iii) graphene, and/or graphite having an aspect ratio greater than 2;
and wherein the concentration of thermally conductive filler in Component A and/or Component B is sufficient to yield a concentration of 40 to 80 wt % thermally conductive filler in the adhesive when Component A and Component B are mixed together to form the adhesive.

In a second aspect, the invention provides a thermally-conductive, two-component polyurethane adhesive made by mixing a first component (A) and a second component (B) wherein the components comprise:
(A) (a1) at least one polyisocyanate;
(B) (b1) at least one polyetherpolyol; and
   (b2) at least one catalyst capable of catalyzing the reaction of a hydroxyl group with an isocyanate group;
wherein Component A and/or Component B comprise (a2, b3) thermally conductive filler which comprises:
   (i) aluminium trihydroxide having a multimodal particle size distribution;
   (ii) expandable graphite, and
   (iii) graphene, and/or graphite having an aspect ratio greater than 2;
and wherein the concentration of thermally conductive filler in Component A and/or Component B is sufficient to yield a concentration of 40 to 80 wt % thermally conductive filler in the adhesive when Component A and Component B are mixed together to form the adhesive.

In a third aspect, the invention provides a method for adhering two or more substrates, comprising the steps:
(1) providing a thermally-conductive, two-component polyurethane adhesive comprising:
(A) a first component (isocyanate component), comprising:
   (a1) at least one polyisocyanate;
(B) a second component (polyol component), comprising:
   (b1) at least one polyetherpolyol; and
   (b2) at least one catalyst capable of catalyzing the reaction of a hydroxyl group with an isocyanate group;
wherein Component A and/or Component B comprise (a2, b3) thermally conductive filler which comprises:
   (i) aluminium trihydroxide having a multimodal particle size distribution;
   (ii) expandable graphite, and
   (iii) graphene, and/or graphite having an aspect ratio greater than 2;
and wherein the concentration of thermally conductive filler in Component A and/or Component B is sufficient to yield a concentration of 40 to 80 wt % thermally conductive filler in the adhesive when Component A and Component B are mixed together to form the adhesive;
(2) mixing Component A and Component B to produce the adhesive;
(3) applying the adhesive to a first substrate;
(4) bringing a second substrate into adhesive contact with the first substrate;
(5) allowing the adhesive to cure.

In a fourth aspect, the invention provides an adhered structure, comprising:
(1) a first substrate;
(2) a second substrate adhesively bonded to the first substrate by a cured adhesive;
wherein the cured adhesive results from curing a mixture of a first component (A) and a second component (B), wherein the components comprise:
(A) (a1) at least one polyisocyanate;
(B) (b1) at least one polyetherpolyol; and
   (b2) at least one catalyst capable of catalyzing the reaction of a hydroxyl group with an isocyanate group;
wherein Component A and/or Component B comprise (a2, b3) thermally conductive filler which comprises:
   (i) aluminium trihydroxide having a multimodal particle size distribution;
   (ii) expandable graphite, and
   (iii) graphene, and/or graphite having an aspect ratio greater than 2;
and wherein the concentration of thermally conductive filler in Component A and/or Component B is sufficient to yield a concentration of 40 to 80 wt % thermally conductive filler in the adhesive when Component A and Component B are mixed together to form the adhesive.

### DETAILED DESCRIPTION OF THE INVENTION

The inventors have found that it is possible to achieve good thermal conductivity, high bond strength and reasonable elongation using the two-component polyurethane adhesive of the invention.

### Definitions and Abbreviations

MDI 4,4′-Methylenebis(phenyl isocyanate)
HDI Hexamethylene diisocyanate
IPDI isophorone diisocyanate
PU polyurethane
SEC size exclusion chromatography
RH relative humidity

Equivalent and molecular weights are measured by gel permeation chromatography (GPC) with a Malvern Viscothek GPC max equipment. Tetrahydrofuran (THF) was used as an eluent, PL GEL MIXED D (Agilent, 300*7.5 mm, 5 μm) was used as a column, and MALVERN Viscotek TDA (integrated refractive index viscometer and light scattering) was used as a detector.

### Component A

Component A comprises:
(a1) at least one polyisocyanate.

### At Least One Polyisocyanate (a1)

The polyisocyanate is not particularly limited.

Aliphatic and aromatic diisocyanates may be used, with aromatic being preferred. Examples of suitable diisocyanates include toluene diisocyanate (TDI), hexamethylene diisocyanate (HDI), naphthalene diisocyanate (NDI), methylene bis-cyclohexylisocyanate (HMDI) (hydrogenated MDI), MDI (in particular 4,4′- and 4,2-MDI) and isophorone diisocyanate (IPDI), with MDI being particularly preferred.

In a preferred embodiment, the polyisocyanate has an average NCO functionality of greater than 2, more preferably 2.1 or greater, particularly preferably 2.15 or greater.

The desired NCO functionality can be achieved using either a single polyisocyanate having an average NCO functionality in the desired range, or a mixture of isocyanates having different average NCO functionalities in proportions that yield an average NCO functionality in the desired range.

The functionality f of the polyisocyanate is calculated:

$$f = {M}_{n} / equivalent weight$$

where Mₙ is number average molecular weight, and “equivalent weight” is the mass in grams of a molecule divided by the number of reactive groups per molecule (in the case of isocyanates, this is the NCO group), or for a mixture:

$$f = number equivalent weight of the mixture * NCO number / 42.$$

In a preferred embodiment, the polyisocyanate has an average NCO functionality within the range of 2.1 to 4.0, more preferably 2.1 to 3.5, more particularly preferably 2.15 to 3.0.

In a preferred embodiment, the polyisocyanate is selected from polymeric MDI, polycarbodiimide-modified MDI, and mixtures of these.

In a particularly preferred embodiment, the polyisocyanate is selected from polymeric MDI, polycarbodiimide-modified MDI, both preferably having an average NCO functionality of 2.1 or greater, and mixtures of these

In a preferred embodiment, the polyisocyanate is a prepolymer which is formed by reaction of at least one molecule bearing two or more isocyanate groups with a polyol, such that the terminal groups are isocyanate groups.

In another preferred embodiment, the polyisocyanate is a prepolymer which is formed by reaction of at least one molecule bearing two or more isocyanate groups with a polyether polyol, such that the terminal groups are isocyanate groups.

In another preferred embodiment, the polyisocyanate is a prepolymer which is formed by reaction of at least one molecule bearing two or more isocyanate groups, having an average NCO functionality of greater than 2, more preferably 2.1 or greater, more particularly preferably 2.15 or greater, with a polyether polyol, such that the terminal groups are isocyanate groups.

In another preferred embodiment, the polyisocyanate is a prepolymer which is formed by reaction of at least one molecule bearing two or more isocyanate groups with a polyether polyol diol, such that the terminal groups are isocyanate groups.

In another preferred embodiment, the polyisocyanate is a prepolymer which is formed by reaction of at least one molecule bearing two or more isocyanate groups with a poly(propylene oxide)-based polyol, such that the terminal groups are isocyanate groups.

In another preferred embodiment, the polyisocyanate is a prepolymer which is formed by reaction of at least one molecule bearing two or more isocyanate groups with a poly(propylene oxide)-based diol, such that the terminal groups are isocyanate groups.

In another preferred embodiment, the polyisocyanate is a prepolymer formed by reaction MDI with a polyether polyol. More preferably the prepolymer is formed by reaction of MDI with a polyether polyol diol.

In another preferred embodiment, the polyisocyanate is a prepolymer formed by reaction MDI with a poly(propylene oxide)-based polyol.

In another preferred embodiment, the polyisocyanate is a prepolymer formed by reaction MDI with a poly(propylene oxide)-based diol.

In another preferred embodiment, the polyisocyanate is a prepolymer formed by reaction MDI with a first poly(propylene oxide)-based diol having an equivalent weight of 700 g/eq or greater and a second poly(propylene oxide)-based diol having an equivalent weight of 500 g/eq or less.

In another preferred embodiment, the polyisocyanate is a prepolymer formed by reaction MDI with a mixture of a first poly(propylene oxide)-based diol having an equivalent weight of 1001 g/eq and a second poly(propylene oxide)-based diol having an equivalent weight of 215 g/eq.

In another preferred embodiment, the prepolymer has an average NCO functionality of greater than 2.0, more preferably 2.1 or greater, more particularly preferably 2.15 or greater.

In another preferred embodiment, the prepolymer is made by reacting MDI and/or polymeric MDI with a poly(propylene oxide)-based diol, such that the prepolymer has an average NCO content of greater than 2.0, more preferably 2.1 or greater, more particularly preferably 2.15 or greater.

The prepolymer can be formed in situ when formulating Component A, simply by mixing a polyisocyanate with a polyol or polyols when compounding Component A.

In a particularly preferred embodiment, the polyisocyanate is a prepolymer formed by reaction of a polyisocyanate and a polyol, comprising: 65-85 wt % polyisocyanate and 15-35 wt % polyol. More preferably, the prepolymer comprises 70-80 wt % polyisocyanate and 20-30 wt % polyol, based on the total weight of the prepolymer.

In a particularly preferred embodiment, the polyisocyanate is a prepolymer formed by reaction of 65-85 wt % MDI and 15-35 wt % poly(propylene oxide)-based diol.

In a preferred embodiment, the prepolymer has a content of urethane groups (“hard segment”) that is greater than 20 wt %, more preferably greater than 29 wt %, more particularly preferably greater than 35 wt %, based on the total weight of the prepolymer. The hard segment content is calculated by summing the weight of aromatic MDI and polymeric MDI used to make the prepolymer, and calculating the wt % based on the total weight of the isocyanate component.

In a preferred embodiment, the prepolymer has a hard segment content that is sufficient that the hard segment content of the fully cured adhesive is greater than 10 wt %, more preferably greater than 20 wt %, and particularly preferably greater than 25 wt %.

### Thermally Conductive Filler

Component A and/or Component B comprise a specific thermally conductive filler package. The thermally conductive filler may be present in Component A or Component B or both, and the concentration of thermally conductive filler in Component A and/or Component B is sufficient to yield a concentration of 40 to 80 wt %, more preferably 40 to 60 wt % thermally conductive filler in the adhesive, based on the total weight of the adhesive, when Component A and Component B are mixed together to form the adhesive.

In a preferred embodiment, the thermally conductive filler is present in Component A at 40 to 80 wt %, more preferably 40 to 60 wt %, based on the total weight of Component A.

In another preferred embodiment, the thermally conductive filler is present in Component B at 40 to 80 wt %, more preferably 40 to 60 wt %, based on the total weight of Component B.

In another preferred embodiment, the thermally conductive filler is present in Component A at 40 to 80 wt %, more preferably 40 to 60 wt %, based on the total weight of Component A, and the thermally conductive filler is present in Component B at 40 to 80 wt %, more preferably 40 to 60 wt %, based on the total weight of Component B.

The thermally conductive filler is preferably present in the final adhesive at a concentration that gives a thermal conductivity of at or about 1.1 W/mK or more, after curing for 7 days at 23° C.

If Component A and Component B are mixed in a volumetric ratio of 1:1, the preferred concentration of the thermally conductive filler in Component A is from 40 to 80 wt %, more preferably 50 to 60 wt %, based on the total weight of Component A.

If Component A and Component B are mixed in a volumetric ratio of 1:1, the preferred concentration of the thermally conductive filler in Component B is from 40 to 80 wt %, more preferably 50 to 60 wt %, based on the total weight of Component B.

The thermally conductive filler comprises:
(i) aluminium trihydroxide having a multimodal particle size distribution;
(ii) expandable graphite, and
(iii) graphene, and/or graphite having an aspect ratio greater than 2.

The expression multimodal particle size distribution means that if the particle sizes are plotted with particle size on the x-axis and vol % on the y-axis, at least two main peaks are observed.

In a preferred embodiment, the aluminium trihydroxide is bimodal.

The particle size distribution of the aluminium trihydroxide is typically measured using laser diffraction, using water containing sodium pyrophosphate as a suspending agent.

In a preferred embodiment, the aluminium trihydroxide has the following particle size distribution: 1-20 vol %<1 μm, 10-30 vol % 1-10 μm, 5-30 vol. % 10-20 μm, >10 vol % 20-50 μm and >20 vol % 50-100 μm.

In a more preferred embodiment, the aluminium trihydroxide has the following particle size distribution: 1-10 vol %<1 μm, 5-20 vol % 1-10 μm, 6-20 vol % 10-20 μm, 5-40 vol % 20-50 μm and 35-60 vol % 50-100 μm.

In a more particularly preferred embodiment, the aluminium trihydroxide has the following particle size distribution: 1-5 vol %<1 μm, 5-15 vol % 1-10 μm, 6-15 vol % 10-20 μm, 20-40 vol % 20-50 μm and 40-70 vol % 50-100 μm.

The aluminum trihydroxide preferably comprises a mixture of aluminium trihydroxides having the following particle size distributions:
ATH1. a first aluminium trihydroxide having a particle size distribution as follows:
   D₁₀ 10 μm
   D₅₀ 8 μm
   D₉₀ 100 μm;
ATH2. a second aluminium trihydroxide having a particle size distribution as follows:
   D₅₀ 8 μm
   D₉₀ 18 μm.

In a preferred embodiment, the aluminium trihydroxide comprises 75 to 90 wt %, more preferably 80 to 90 wt %, particularly preferably 85 to 88 wt % ATH1 and 10 to 25 wt %, more preferably 10 to 20 wt %, particularly preferably 12 to 15 wt % ATH2, based on the total weight of aluminium trihydroxide.

The total amount of aluminium trihydroxide in Component A and/or Component B is preferably 40 to 60 wt %, more preferably 45 to 55 wt %, particularly preferably 47 to 52 wt %, based on the total weight of the relevant Component.

The thermally conductive filler comprises expandable graphite. Expandable graphite is graphite that if heated, usually to temperatures in the range of 200° C. to 250° C., expands to several fold over its starting volume. The minimum expansion rates is preferably 100 cm³/g.

The expandable graphite preferably has a particle size distribution as follows: 1-10 vol % larger than 50 μm, 20-50 vol % larger than 150 μm and 30-80 vol % larger than 300 μm.

The particle size distribution of the expandable graphite is measured according to DIN 66165 part 1, with a 63-5000 μm sieve (according to DIN 4188).

In a preferred embodiment, the expandable graphite is a mixture of expandable graphites:
GR1. A first expandable graphite wherein 75 vol % has a particle size of <150 μm, and an expansion rate of 100 cm³/g
GR2. A second expandable graphite wherein 80 vol % has a particle size of >300 μm, and an expansion rate of 250 cm³/g.

In a preferred embodiment, the expandable graphite comprises 40 to 80 wt %, more preferably 45 to 75 wt %, particularly preferably 50 to 75 wt % GR1, and 40 to 80 wt %, more preferably 45 to 75 wt %, particularly preferably 50 to 75 wt % GR2, based on the total weight of expandable graphite.

The total amount of expandable graphite in Component A and/or Component B is preferably 2 to 10 wt %, more preferably 4 to 8 wt %, particularly preferably 6 wt %, based on the total weight of the relevant Component.

The thermally conductive filer comprises graphene, and/or graphite having an aspect ratio greater than 2.

Graphene is an allotrope of carbon consisting of a single layer of atoms arranged in a two-dimensional honeycomb lattice nanostructure.

In a preferred embodiment, the graphene has a volume average platelet size of from 10 to 30 μm, more preferably 20-30 μm, particularly preferably 24 to 26 μm.

The average platelet size of the graphene is typically measured according to DIN 66165 part 1, with a 63-5000 μm sieve (according to DIN 4188).

In another preferred embodiment, the graphite having an aspect ratio greater than 2 has an aspect ratio greater than 3, more preferably greater than 4. The graphite having an aspect ratio of greater than 2 is preferably selected from graphite particles, graphene platelets and mixtures of these.

In a preferred embodiment, the graphite having an aspect ratio of greater than 2 is graphite particles having a D₉₀ of 80-110 μm, more preferably 85-95 μm.

In another preferred embodiment, the graphite having an aspect ratio of greater than 2 is graphene nanoplatelets, with a thickness of 10-30 nm, more preferably 16-20 nm, and an average particle size of 10-35 μm, more preferably 15-30 μm, particularly preferably 24-26 μm.

In another preferred embodiment, the graphite having an aspect ratio greater than 2 has an aspect ratio greater than 3, more preferably greater than 4, and it is in the form of particles having a D₉₀ of 80-110 μm, more preferably 85-95 μm.

The amount of graphene, and/or graphite having an aspect ratio greater than 2, in Component A and/or Component B is preferably 0.5 to 2 wt %, more preferably 0.75 to 1.5 wt %, particularly preferably 1 to 1.3 wt %, based on the total weight of the relevant component.

In a preferred embodiment, the thermally conductive filler comprises:
(i) 75 to 95 wt % aluminium trihydroxide having a multimodal (preferably bimodal) particle size distribution;
(ii) 5 to 15 wt % expandable graphite, and
(iii) 0.5 to 4 wt % graphene, and/or graphite having an aspect ratio greater than 2,
wherein the wt %'s are based on the total weight of thermally conductive filler.

In another preferred embodiment, the thermally conductive filler comprises:
(i) 80 to 90 wt % aluminium trihydroxide having a multimodal (preferably bimodal) particle size distribution;
(ii) 7 to 12 wt % expandable graphite, and
(iii) 1 to 3 wt % graphene, and/or graphite having an aspect ratio greater than 2,
wherein the wt %'s are based on the total weight of thermally conductive filler.

In another preferred embodiment, the thermally conductive filler comprises:
(i) 85 to 88 wt % aluminium trihydroxide having a multimodal (preferably bimodal) particle size distribution;
(ii) 9 to 11 wt % expandable graphite, and
(iii) 1.5 to 2.5 wt % graphene, and/or graphite having an aspect ratio greater than 2,
wherein the wt %'s are based on the total weight of thermally conductive filler.

In another preferred embodiment, the thermally conductive filler comprises:
(i) 75 to 95 wt % aluminium trihydroxide having a multimodal (preferably bimodal) particle size distribution;
(ii) 5 to 15 wt % expandable graphite, having the following particle size distribution 1-10 vol % larger than 50 μm, 20-50 vol % larger than 150 μm and 30-80 vol % larger than 300 μm, and
(iii) 0.5 to 4 wt % graphene, and/or graphite having an aspect ratio greater than 2,
wherein the wt %'s are based on the total weight of thermally conductive filler.

In another preferred embodiment, the thermally conductive filler comprises:
(i) 80 to 90 wt % aluminium trihydroxide having a multimodal (preferably bimodal) particle size distribution;
(ii) 7 to 12 wt % expandable graphite, having the following particle size distribution 1-10 vol % larger than 50 μm, 20-50 vol % larger than 150 μm and 30-80 vol % larger than 300 μm, and
(iii) 1 to 3 wt % graphene, and/or graphite having an aspect ratio greater than 2,
wherein the wt %'s are based on the total weight of thermally conductive filler.

In another preferred embodiment, the thermally conductive filler comprises:
(i) 85 to 88 wt % aluminium trihydroxide having a multimodal (preferably bimodal) particle size distribution;
(ii) 9 to 11 wt % expandable graphite, having the following particle size distribution 1-10 vol % larger than 50 μm, 20-50 vol % larger than 150 μm and 30-80 vol % larger than 300 μm, and
(iii) 1.5 to 2.5 wt % graphene, and/or graphite having an aspect ratio greater than 2,
wherein the wt %'s are based on the total weight of thermally conductive filler.

In a preferred embodiment, the thermally conductive filler comprises:
(i) 75 to 95 wt % aluminium trihydroxide having a multimodal (preferably bimodal) particle size distribution;
(ii) 5 to 15 wt % expandable graphite which is a mixture of expandable graphites:
GR1. A first expandable graphite wherein 75 vol % has a particle size of <150 μm;
GR2. A second expandable graphite wherein 80 vol % has a particle size of >300 μm; and
(iii) 0.5 to 4 wt % graphene, and/or graphite having an aspect ratio greater than 2,
wherein the wt %'s are based on the total weight of thermally conductive filler.

In another preferred embodiment, the thermally conductive filler comprises:
(i) 80 to 90 wt % aluminium trihydroxide having a multimodal (preferably bimodal) particle size distribution;
(ii) 7 to 12 wt % expandable graphite which is a mixture of expandable graphites:
GR1. A first expandable graphite wherein 75 vol % has a particle size of <150 μm;
GR2. A second expandable graphite wherein 80 vol % has a particle size of >300 μm; and
(iii) 1 to 3 wt % graphene, and/or graphite having an aspect ratio greater than 2,
wherein the wt %'s are based on the total weight of thermally conductive filler.

In another preferred embodiment, the thermally conductive filler comprises:
(i) 85 to 88 wt % aluminium trihydroxide having a multimodal (preferably bimodal) particle size distribution;
(ii) 9 to 11 wt % expandable graphite which is a mixture of expandable graphites:
GR1. A first expandable graphite wherein 75 vol % has a particle size of <150 μm;
GR2. A second expandable graphite wherein 80 vol % has a particle size of >300 μm; and
(iii) 1.5 to 2.5 wt % graphene, and/or graphite having an aspect ratio greater than 2,
wherein the wt %'s are based on the total weight of thermally conductive filler.

In a preferred embodiment, the thermally conductive filler comprises:
(i) 75 to 95 wt % aluminium trihydroxide having a multimodal (preferably bimodal) particle size distribution;
(ii) 5 to 15 wt % expandable graphite, and
(iii) 0.5 to 4 wt % graphene, having a volume average platelet size of from 10 to 30 μm, more preferably 20-30 μm, particularly preferably 24 to 26 μm;
wherein the wt %'s are based on the total weight of thermally conductive filler.

In another preferred embodiment, the thermally conductive filler comprises:
(i) 80 to 90 wt % aluminium trihydroxide having a multimodal (preferably bimodal) particle size distribution;
(ii) 7 to 12 wt % expandable graphite, and
(iii) 1 to 3 wt % graphene, having a volume average platelet size of from 10 to 30 μm, more preferably 20-30 μm, particularly preferably 24 to 26 μm;
wherein the wt %'s are based on the total weight of thermally conductive filler.

In another preferred embodiment, the thermally conductive filler comprises:
(i) 85 to 88 wt % aluminium trihydroxide having a multimodal (preferably bimodal) particle size distribution;
(ii) 9 to 11 wt % expandable graphite, and
(iii) 1.5 to 2.5 wt % graphene, having a volume average platelet size of from 10 to 30 μm, more preferably 20-30 μm, particularly preferably 24 to 26 μm;
wherein the wt %'s are based on the total weight of thermally conductive filler.

In a preferred embodiment, the thermally conductive filler comprises:
(i) 75 to 95 wt % aluminium trihydroxide having a multimodal (preferably bimodal) particle size distribution;
(ii) 5 to 15 wt % expandable graphite, and
(iii) 0.5 to 4 wt % graphite having an aspect ratio of greater than 3, more preferably greater than 4;
wherein the wt %'s are based on the total weight of thermally conductive filler.

In another preferred embodiment, the thermally conductive filler comprises:
(i) 80 to 90 wt % aluminium trihydroxide having a multimodal (preferably bimodal) particle size distribution;
(ii) 7 to 12 wt % expandable graphite, and
(iii) 1 to 3 wt % graphite having an aspect ratio of greater than 3, more preferably greater than 4;
wherein the wt %'s are based on the total weight of thermally conductive filler.

In another preferred embodiment, the thermally conductive filler comprises:
(i) 85 to 88 wt % aluminium trihydroxide having a multimodal (preferably bimodal) particle size distribution;
(ii) 9 to 11 wt % expandable graphite, and
(iii) 1.5 to 2.5 wt % graphite having an aspect ratio of greater than 3, more preferably greater than 4;
wherein the wt %'s are based on the total weight of thermally conductive filler.

In a preferred embodiment, the thermally conductive filler comprises:
(i) 75 to 95 wt % aluminium trihydroxide having a multimodal (preferably bimodal) particle size distribution;
(ii) 5 to 15 wt % expandable graphite, and
(iii) 0.5 to 4 wt % graphite having an aspect ratio of greater than 2 in the form of particles having a D₉₀ of 80-110 μm, more preferably 85-95 μm;
wherein the wt %'s are based on the total weight of thermally conductive filler.

In another preferred embodiment, the thermally conductive filler comprises:
(i) 80 to 90 wt % aluminium trihydroxide having a multimodal (preferably bimodal) particle size distribution;
(ii) 7 to 12 wt % expandable graphite, and
(iii) 1 to 3 wt % graphite having an aspect ratio of greater than 2 in the form of particles having a D₉₀ of 80-110 μm, more preferably 85-95 μm;
wherein the wt %'s are based on the total weight of thermally conductive filler.

In another preferred embodiment, the thermally conductive filler comprises:
(i) 85 to 88 wt % aluminium trihydroxide having a multimodal (preferably bimodal) particle size distribution;
(ii) 9 to 11 wt % expandable graphite, and
(iii) 1.5 to 2.5 wt % graphite having an aspect ratio of greater than 2 in the form of particles having a D₉₀ of 80-110 μm, more preferably 85-95 μm;
wherein the wt %'s are based on the total weight of thermally conductive filler.

In a preferred embodiment, the adhesive resulting from mixing Component A and Component B comprises:
(i) 40 to 60 wt % aluminium trihydroxide having a multimodal (preferably bimodal) particle size distribution;
(ii) 3 to 10 wt % expandable graphite, and
(iii) 0.5 to 3 wt % graphene, and/or graphite having an aspect ratio greater than 2,
based on the total weight of the adhesive.

In another preferred embodiment, the adhesive resulting from mixing Component A and Component B comprises:
(i) 45 to 55 wt % aluminium trihydroxide having a multimodal (preferably bimodal) particle size distribution;
(ii) 4 to 7 wt % expandable graphite, and
(iii) 0.75 to 1.5 wt % graphene, and/or graphite having an aspect ratio greater than 2,
based on the total weight of the adhesive.

In another preferred embodiment, the adhesive resulting from mixing Component A and Component B comprises:
(i) 48 to 50 wt % aluminium trihydroxide having a multimodal (preferably bimodal) particle size distribution;
(ii) 5.5 to 6.5 wt % expandable graphite, and
(iii) 1 to 1.3 wt % graphene, and/or graphite having an aspect ratio greater than 2,
based on the total weight of the adhesive.

In a preferred embodiment, the adhesive resulting from mixing Component A and Component B comprises:
(i) 40 to 60 wt % aluminium trihydroxide having a multimodal (preferably bimodal) particle size distribution;
(ii) 3 to 10 wt % expandable graphite, having the following particle size distribution 1-10 vol % larger than 50 μm, 20-50 vol % larger than 150 μm and 30-80 vol % larger than 300 μm, and
(iii) 0.5 to 3 wt % graphene, and/or graphite having an aspect ratio greater than 2,
based on the total weight of the adhesive.

In another preferred embodiment, the adhesive resulting from mixing Component A and Component B comprises:
(i) 45 to 55 wt % aluminium trihydroxide having a multimodal (preferably bimodal) particle size distribution;
(ii) 4 to 7 wt % expandable graphite, having the following particle size distribution 1-10 vol % larger than 50 μm, 20-50 vol % larger than 150 μm and 30-80 vol % larger than 300 μm, and
(iii) 0.75 to 1.5 wt % graphene, and/or graphite having an aspect ratio greater than 2,
based on the total weight of the adhesive.

In another preferred embodiment, the adhesive resulting from mixing Component A and Component B comprises:
(i) 48 to 50 wt % aluminium trihydroxide having a multimodal (preferably bimodal) particle size distribution;
(ii) 5.5 to 6.5 wt % expandable graphite, having the following particle size distribution 1-10 vol % larger than 50 μm, 20-50 vol % larger than 150 μm and 30-80 vol % larger than 300 μm, and
(iii) 1 to 1.3 wt % graphene, and/or graphite having an aspect ratio greater than 2,
based on the total weight of the adhesive.

In a preferred embodiment, the adhesive resulting from mixing Component A and Component B comprises:
(i) 40 to 60 wt % aluminium trihydroxide having a multimodal (preferably bimodal) particle size distribution;
(ii) 3 to 10 wt % expandable graphite, and
(iii) 0.5 to 3 wt % graphene, having a volume average platelet size of from 10 to 30 μm, more preferably 20-30 μm, particularly preferably 24 to 26 μm;
based on the total weight of the adhesive.

In another preferred embodiment, the adhesive resulting from mixing Component A and Component B comprises:
(i) 45 to 55 wt % aluminium trihydroxide having a multimodal (preferably bimodal) particle size distribution;
(ii) 4 to 7 wt % expandable graphite, and
(iii) 0.75 to 1.5 wt % graphene, having a volume average platelet size of from 10 to 30 μm, more preferably 20-30 μm, particularly preferably 24 to 26 μm;
based on the total weight of the adhesive.

In another preferred embodiment, the adhesive resulting from mixing Component A and Component B comprises:
(i) 48 to 50 wt % aluminium trihydroxide having a multimodal (preferably bimodal) particle size distribution;
(ii) 5.5 to 6.5 wt % expandable graphite, and
(iii) 1 to 1.3 wt % graphene, having a volume average platelet size of from 10 to 30 μm, more preferably 20-30 μm, particularly preferably 24 to 26 μm;
based on the total weight of the adhesive.

In a preferred embodiment, the adhesive resulting from mixing Component A and Component B comprises:
(i) 40 to 60 wt % aluminium trihydroxide having a multimodal (preferably bimodal) particle size distribution;
(ii) 3 to 10 wt % expandable graphite, and
(iii) 0.5 to 3 wt % graphite having an aspect ratio of greater than 3, more preferably greater than 4;
based on the total weight of the adhesive.

In another preferred embodiment, the adhesive resulting from mixing Component A and Component B comprises:
(i) 45 to 55 wt % aluminium trihydroxide having a multimodal (preferably bimodal) particle size distribution;
(ii) 4 to 7 wt % expandable graphite, and
(iii) 0.75 to 1.5 wt % graphite having an aspect ratio of greater than 3, more preferably greater than 4;
based on the total weight of the adhesive.

In another preferred embodiment, the adhesive resulting from mixing Component A and Component B comprises:
(i) 48 to 50 wt % aluminium trihydroxide having a multimodal (preferably bimodal) particle size distribution;
(ii) 5.5 to 6.5 wt % expandable graphite, and
(iii) 1 to 1.3 wt % graphite having an aspect ratio of greater than 3, more preferably greater than 4;
based on the total weight of the adhesive.

In a preferred embodiment, the adhesive resulting from mixing Component A and Component B comprises:
(i) 40 to 60 wt % aluminium trihydroxide having a multimodal (preferably bimodal) particle size distribution;
(ii) 3 to 10 wt % expandable graphite, and
(iii) 0.5 to 3 wt % graphite having an aspect ratio of greater than 2 in the form of particles having a D₉₀ of 80-110 μm, more preferably 85-95 μm;
based on the total weight of the adhesive.

In another preferred embodiment, the adhesive resulting from mixing Component A and Component B comprises:
(i) 45 to 55 wt % aluminium trihydroxide having a multimodal (preferably bimodal) particle size distribution;
(ii) 4 to 7 wt % expandable graphite, and
(iii) 0.75 to 1.5 wt % graphite having an aspect ratio of greater than 2 in the form of particles having a D₉₀ of 80-110 μm, more preferably 85-95 μm;
based on the total weight of the adhesive.

In another preferred embodiment, the adhesive resulting from mixing Component A and Component B comprises:
(i) 48 to 50 wt % aluminium trihydroxide having a multimodal (preferably bimodal) particle size distribution;
(ii) 5.5 to 6.5 wt % expandable graphite, and
(iii) 1 to 1.3 wt % graphite having an aspect ratio of greater than 2 in the form of particles having a D₉₀ of 80-110 μm, more preferably 85-95 μm;
based on the total weight of the adhesive.

In a preferred embodiment, the thermally conductive filler comprises:
(i) 75 to 95 wt % aluminium trihydroxide having the following particle size distribution: 1-20 vol %<1 μm, 10-30 vol % 1-10 μm, 5-30 vol. % 10-20 μm, >10 vol % 20-50 μm and >20 vol % 50-100 μm;
(ii) 5 to 15 wt % expandable graphite, and
(iii) 0.5 to 4 wt % graphene, and/or graphite having an aspect ratio greater than 2,
wherein the wt %'s are based on the total weight of thermally conductive filler.

In another preferred embodiment, the thermally conductive filler comprises:
(i) 80 to 90 wt % aluminium trihydroxide having the following particle size distribution: 1-20 vol %<1 μm, 10-30 vol % 1-10 μm, 5-30 vol. % 10-20 μm, >10 vol % 20-50 μm and >20 vol % 50-100 μm;
(ii) 7 to 12 wt % expandable graphite, and
(iii) 1 to 3 wt % graphene, and/or graphite having an aspect ratio greater than 2,
wherein the wt %'s are based on the total weight of thermally conductive filler.

In another preferred embodiment, the thermally conductive filler comprises:
(i) 85 to 88 wt % aluminium trihydroxide having the following particle size distribution: 1-20 vol %<1 μm, 10-30 vol % 1-10 μm, 5-30 vol. % 10-20 μm, >10 vol % 20-50 μm and >20 vol % 50-100 μm;
(ii) 9 to 11 wt % expandable graphite, and
(iii) 1.5 to 2.5 wt % graphene, and/or graphite having an aspect ratio greater than 2,
wherein the wt %'s are based on the total weight of thermally conductive filler.

In another preferred embodiment, the thermally conductive filler comprises:
(i) 75 to 95 wt % aluminium trihydroxide having the following particle size distribution: 1-20 vol %<1 μm, 10-30 vol % 1-10 μm, 5-30 vol. % 10-20 μm, >10 vol % 20-50 μm and >20 vol % 50-100 μm;
(ii) 5 to 15 wt % expandable graphite, having the following particle size distribution 1-10 vol % larger than 50 μm, 20-50 vol % larger than 150 μm and 30-80 vol % larger than 300 μm, and
(iii) 0.5 to 4 wt % graphene, and/or graphite having an aspect ratio greater than 2,
wherein the wt %'s are based on the total weight of thermally conductive filler.

In another preferred embodiment, the thermally conductive filler comprises:
(i) 80 to 90 wt % aluminium trihydroxide having the following particle size distribution: 1-20 vol %<1 μm, 10-30 vol % 1-10 μm, 5-30 vol. % 10-20 μm, >10 vol % 20-50 μm and >20 vol % 50-100 μm;
(ii) 7 to 12 wt % expandable graphite, having the following particle size distribution 1-10 vol % larger than 50 μm, 20-50 vol % larger than 150 μm and 30-80 vol % larger than 300 μm, and
(iii) 1 to 3 wt % graphene, and/or graphite having an aspect ratio greater than 2,
wherein the wt %'s are based on the total weight of thermally conductive filler.

In another preferred embodiment, the thermally conductive filler comprises:
(i) 85 to 88 wt % aluminium trihydroxide having the following particle size distribution:
1-20 vol %<1 μm, 10-30 vol % 1-10 μm, 5-30 vol. % 10-20 μm, >10 vol % 20-50 μm and >20 vol % 50-100 μm;
(ii) 9 to 11 wt % expandable graphite, having the following particle size distribution 1-10 vol % larger than 50 μm, 20-50 vol % larger than 150 μm and 30-80 vol % larger than 300 μm, and
(iii) 1.5 to 2.5 wt % graphene, and/or graphite having an aspect ratio greater than 2,
wherein the wt %'s are based on the total weight of thermally conductive filler.

In a preferred embodiment, the thermally conductive filler comprises:
(i) 75 to 95 wt % aluminium trihydroxide having the following particle size distribution: 1-20 vol %<1 μm, 10-30 vol % 1-10 μm, 5-30 vol. % 10-20 μm, >10 vol % 20-50 μm and >20 vol % 50-100 μm;
(ii) 5 to 15 wt % expandable graphite which is a mixture of expandable graphites:
GR1. A first expandable graphite wherein 75 vol % has a particle size of <150 μm;
GR2. A second expandable graphite wherein 80 vol % has a particle size of >300 μm; and
(iii) 0.5 to 4 wt % graphene, and/or graphite having an aspect ratio greater than 2,
wherein the wt %'s are based on the total weight of thermally conductive filler.

In another preferred embodiment, the thermally conductive filler comprises:
(i) 80 to 90 wt % aluminium trihydroxide having the following particle size distribution: 1-20 vol %<1 μm, 10-30 vol % 1-10 μm, 5-30 vol. % 10-20 μm, >10 vol % 20-50 μm and >20 vol % 50-100 μm;
(ii) 7 to 12 wt % expandable graphite which is a mixture of expandable graphites:
GR1. A first expandable graphite wherein 75 vol % has a particle size of <150 μm;
GR2. A second expandable graphite wherein 80 vol % has a particle size of >300 μm; and
(iii) 1 to 3 wt % graphene, and/or graphite having an aspect ratio greater than 2,
wherein the wt %'s are based on the total weight of thermally conductive filler.

In another preferred embodiment, the thermally conductive filler comprises:
(i) 85 to 88 wt % aluminium trihydroxide having the following particle size distribution: 1-20 vol %<1 μm, 10-30 vol % 1-10 μm, 5-30 vol. % 10-20 μm, >10 vol % 20-50 μm and >20 vol % 50-100 μm;
(ii) 9 to 11 wt % expandable graphite which is a mixture of expandable graphites:
GR1. A first expandable graphite wherein 75 vol % has a particle size of <150 μm;
GR2. A second expandable graphite wherein 80 vol % has a particle size of >300 μm; and
(iii) 1.5 to 2.5 wt % graphene, and/or graphite having an aspect ratio greater than 2,
wherein the wt %'s are based on the total weight of thermally conductive filler.

In a preferred embodiment, the thermally conductive filler comprises:
(i) 75 to 95 wt % aluminium trihydroxide having the following particle size distribution: 1-20 vol %<1 μm, 10-30 vol % 1-10 μm, 5-30 vol. % 10-20 μm, >10 vol % 20-50 μm and >20 vol % 50-100 μm;
(ii) 5 to 15 wt % expandable graphite, and
(iii) 0.5 to 4 wt % graphene, having a volume average platelet size of from 10 to 30 μm, more preferably 20-30 μm, particularly preferably 24 to 26 μm;
wherein the wt %'s are based on the total weight of thermally conductive filler.

In another preferred embodiment, the thermally conductive filler comprises:
(i) 80 to 90 wt % aluminium trihydroxide having the following particle size distribution:
1-20 vol %<1 μm, 10-30 vol % 1-10 μm, 5-30 vol. % 10-20 μm, >10 vol % 20-50 μm and >20 vol % 50-100 μm;
(ii) 7 to 12 wt % expandable graphite, and
(iii) 1 to 3 wt % graphene, having a volume average platelet size of from 10 to 30 μm, more preferably 20-30 μm, particularly preferably 24 to 26 μm;
wherein the wt %'s are based on the total weight of thermally conductive filler.

In another preferred embodiment, the thermally conductive filler comprises:
(i) 85 to 88 wt % aluminium trihydroxide having the following particle size distribution: 1-20 vol %<1 μm, 10-30 vol % 1-10 μm, 5-30 vol. % 10-20 μm, >10 vol % 20-50 μm and >20 vol % 50-100 μm;
(ii) 9 to 11 wt % expandable graphite, and
(iii) 1.5 to 2.5 wt % graphene, having a volume average platelet size of from 10 to 30 μm, more preferably 20-30 μm, particularly preferably 24 to 26 μm;
wherein the wt %'s are based on the total weight of thermally conductive filler.

In a preferred embodiment, the thermally conductive filler comprises:
(i) 75 to 95 wt % aluminium trihydroxide having the following particle size distribution: 1-20 vol %<1 μm, 10-30 vol % 1-10 μm, 5-30 vol. % 10-20 μm, >10 vol % 20-50 μm and >20 vol % 50-100 μm;
(ii) 5 to 15 wt % expandable graphite, and
(iii) 0.5 to 4 wt % graphite having an aspect ratio of greater than 3, more preferably greater than 4;
wherein the wt %'s are based on the total weight of thermally conductive filler.

In another preferred embodiment, the thermally conductive filler comprises:
(i) 80 to 90 wt % aluminium trihydroxide having the following particle size distribution: 1-20 vol %<1 μm, 10-30 vol % 1-10 μm, 5-30 vol. % 10-20 μm, >10 vol % 20-50 μm and >20 vol % 50-100 μm;
(ii) 7 to 12 wt % expandable graphite, and
(iii) 1 to 3 wt % graphite having an aspect ratio of greater than 3, more preferably greater than 4;
wherein the wt %'s are based on the total weight of thermally conductive filler.

In another preferred embodiment, the thermally conductive filler comprises:
(i) 85 to 88 wt % aluminium trihydroxide having the following particle size distribution: 1-20 vol %<1 μm, 10-30 vol % 1-10 μm, 5-30 vol. % 10-20 μm, >10 vol % 20-50 μm and >20 vol % 50-100 μm;
(ii) 9 to 11 wt % expandable graphite, and
(iii) 1.5 to 2.5 wt % graphite having an aspect ratio of greater than 3, more preferably greater than 4;
wherein the wt %'s are based on the total weight of thermally conductive filler.

In a preferred embodiment, the thermally conductive filler comprises:
(i) 75 to 95 wt % aluminium trihydroxide having the following particle size distribution: 1-20 vol %<1 μm, 10-30 vol % 1-10 μm, 5-30 vol. % 10-20 μm, >10 vol % 20-50 μm and >20 vol % 50-100 μm;
(ii) 5 to 15 wt % expandable graphite, and
(iii) 0.5 to 4 wt % graphite having an aspect ratio of greater than 2 in the form of particles having a D₉₀ of 80-110 μm, more preferably 85-95 μm;
wherein the wt %'s are based on the total weight of thermally conductive filler.

In another preferred embodiment, the thermally conductive filler comprises:
(i) 80 to 90 wt % aluminium trihydroxide having the following particle size distribution: 1-20 vol %<1 μm, 10-30 vol % 1-10 μm, 5-30 vol. % 10-20 μm, >10 vol % 20-50 μm and >20 vol % 50-100 μm;
(ii) 7 to 12 wt % expandable graphite, and
(iii) 1 to 3 wt % graphite having an aspect ratio of greater than 2 in the form of particles having a D₉₀ of 80-110 μm, more preferably 85-95 μm;
wherein the wt %'s are based on the total weight of thermally conductive filler. In another preferred embodiment, the thermally conductive filler comprises:
(i) 85 to 88 wt % aluminium trihydroxide having the following particle size distribution: 1-20 vol %<1 μm, 10-30 vol % 1-10 μm, 5-30 vol. % 10-20 μm, >10 vol % 20-50 μm and >20 vol % 50-100 μm;
(ii) 9 to 11 wt % expandable graphite, and
(iii) 1.5 to 2.5 wt % graphite having an aspect ratio of greater than 2 in the form of particles having a D₉₀ of 80-110 μm, more preferably 85-95 μm;
wherein the wt %'s are based on the total weight of thermally conductive filler.

In a preferred embodiment, the adhesive resulting from mixing Component A and Component B comprises:
(i) 40 to 60 wt % aluminium trihydroxide having the following particle size distribution: 1-20 vol %<1 μm, 10-30 vol % 1-10 μm, 5-30 vol. % 10-20 μm, >10 vol % 20-50 μm and >20 vol % 50-100 μm;
(ii) 3 to 10 wt % expandable graphite, and
(iii) 0.5 to 3 wt % graphene, and/or graphite having an aspect ratio greater than 2,
based on the total weight of the adhesive.

In another preferred embodiment, the adhesive resulting from mixing Component A and Component B comprises:
(i) 45 to 55 wt % aluminium trihydroxide having the following particle size distribution: 1-20 vol %<1 μm, 10-30 vol % 1-10 μm, 5-30 vol. % 10-20 μm, >10 vol % 20-50 μm and >20 vol % 50-100 μm;
(ii) 4 to 7 wt % expandable graphite, and
(iii) 0.75 to 1.5 wt % graphene, and/or graphite having an aspect ratio greater than 2,
based on the total weight of the adhesive.

In another preferred embodiment, the adhesive resulting from mixing Component A and Component B comprises:
(i) 48 to 50 wt % aluminium trihydroxide having the following particle size distribution: 1-20 vol %<1 μm, 10-30 vol % 1-10 μm, 5-30 vol. % 10-20 μm, >10 vol % 20-50 μm and >20 vol % 50-100 μm;
(ii) 5.5 to 6.5 wt % expandable graphite, and
(iii) 1 to 1.3 wt % graphene, and/or graphite having an aspect ratio greater than 2,
based on the total weight of the adhesive.

In a preferred embodiment, the adhesive resulting from mixing Component A and Component B comprises:
(i) 40 to 60 wt % aluminium trihydroxide having the following particle size distribution: 1-20 vol %<1 μm, 10-30 vol % 1-10 μm, 5-30 vol. % 10-20 μm, >10 vol % 20-50 μm and >20 vol % 50-100 μm;
(ii) 3 to 10 wt % expandable graphite, having the following particle size distribution 1-10 vol % larger than 50 μm, 20-50 vol % larger than 150 μm and 30-80 vol % larger than 300 μm, and
(iii) 0.5 to 3 wt % graphene, and/or graphite having an aspect ratio greater than 2,
based on the total weight of the adhesive.

In another preferred embodiment, the adhesive resulting from mixing Component A and Component B comprises:
(i) 45 to 55 wt % aluminium trihydroxide having the following particle size distribution: 1-20 vol %<1 μm, 10-30 vol % 1-10 μm, 5-30 vol. % 10-20 μm, >10 vol % 20-50 μm and >20 vol % 50-100 μm;
(ii) 4 to 7 wt % expandable graphite, having the following particle size distribution 1-10 vol % larger than 50 μm, 20-50 vol % larger than 150 μm and 30-80 vol % larger than 300 μm, and
(iii) 0.75 to 1.5 wt % graphene, and/or graphite having an aspect ratio greater than 2,
based on the total weight of the adhesive.

In another preferred embodiment, the adhesive resulting from mixing Component A and Component B comprises:
(i) 48 to 50 wt % aluminium trihydroxide having the following particle size distribution: 1-20 vol %<1 μm, 10-30 vol % 1-10 μm, 5-30 vol. % 10-20 μm, >10 vol % 20-50 μm and >20 vol % 50-100 μm;
(ii) 5.5 to 6.5 wt % expandable graphite, having the following particle size distribution 1-10 vol % larger than 50 μm, 20-50 vol % larger than 150 μm and 30-80 vol % larger than 300 μm, and
(iii) 1 to 1.3 wt % graphene, and/or graphite having an aspect ratio greater than 2,
based on the total weight of the adhesive.

In a preferred embodiment, the adhesive resulting from mixing Component A and Component B comprises:
(i) 40 to 60 wt % aluminium trihydroxide having the following particle size distribution: 1-20 vol %<1 μm, 10-30 vol % 1-10 μm, 5-30 vol. % 10-20 μm, >10 vol % 20-50 μm and >20 vol % 50-100 μm;
(ii) 3 to 10 wt % expandable graphite, and
(iii) 0.5 to 3 wt % graphene, having a volume average platelet size of from 10 to 30 μm, more preferably 20-30 μm, particularly preferably 24 to 26 μm;
based on the total weight of the adhesive.

In another preferred embodiment, the adhesive resulting from mixing Component A and Component B comprises:
(i) 45 to 55 wt % aluminium trihydroxide having the following particle size distribution: 1-20 vol %<1 μm, 10-30 vol % 1-10 μm, 5-30 vol. % 10-20 μm, >10 vol % 20-50 μm and >20 vol % 50-100 μm;
(ii) 4 to 7 wt % expandable graphite, and
(iii) 0.75 to 1.5 wt % graphene, having a volume average platelet size of from 10 to 30 μm, more preferably 20-30 μm, particularly preferably 24 to 26 μm;
based on the total weight of the adhesive.

In another preferred embodiment, the adhesive resulting from mixing Component A and Component B comprises:
(i) 48 to 50 wt % aluminium trihydroxide having the following particle size distribution: 1-20 vol %<1 μm, 10-30 vol % 1-10 μm, 5-30 vol. % 10-20 μm, >10 vol % 20-50 μm and >20 vol % 50-100 μm;
(ii) 5.5 to 6.5 wt % expandable graphite, and
(iii) 1 to 1.3 wt % graphene, having a volume average platelet size of from 10 to 30 μm, more preferably 20-30 μm, particularly preferably 24 to 26 μm;
based on the total weight of the adhesive.

In another preferred embodiment, the thermally conductive filler comprises:
(i) a mixture of aluminium trihydroxides having the following particle size distributions:
ATH1. a first aluminium trihydroxide having a particle size distribution as follows:
   D₁₀ 10 μm
   D₅₀ 8 μm
   D₉₀ 100 μm;
ATH2. a second aluminium trihydroxide having a particle size distribution as follows:
   D₅₀ 8 μm
   D₉₀ 18 μm;
(ii) expandable graphite that is a mixture of expandable graphites:
GR1. A first expandable graphite wherein 75 vol % has a particle size of <150 μm;
GR2. A second expandable graphite wherein 80 vol % has a particle size of >300 μm; and
(iii) graphene having a volume average platelet size of from 10 to 30 μm, more preferably 20-30 μm, particularly preferably 24 to 26 μm.

In a preferred embodiment, the adhesive resulting from mixing Component A and Component B comprises:
(i) 40 to 60 wt % aluminium trihydroxide having the following particle size distribution: 1-20 vol %<1 μm, 10-30 vol % 1-10 μm, 5-30 vol. % 10-20 μm, >10 vol % 20-50 μm and >20 vol % 50-100 μm;
(ii) 3 to 10 wt % expandable graphite, and
(iii) 0.5 to 3 wt % graphite having an aspect ratio of greater than 3, more preferably greater than 4;
based on the total weight of the adhesive.

In another preferred embodiment, the adhesive resulting from mixing Component A and Component B comprises:
(i) 45 to 55 wt % aluminium trihydroxide having the following particle size distribution: 1-20 vol %<1 μm, 10-30 vol % 1-10 μm, 5-30 vol. % 10-20 μm, >10 vol % 20-50 μm and >20 vol % 50-100 μm;
(ii) 4 to 7 wt % expandable graphite, and
(iii) 0.75 to 1.5 wt % graphite having an aspect ratio of greater than 3, more preferably greater than 4;
based on the total weight of the adhesive.

In another preferred embodiment, the adhesive resulting from mixing Component A and Component B comprises:
(i) 48 to 50 wt % aluminium trihydroxide having the following particle size distribution: 1-20 vol %<1 μm, 10-30 vol % 1-10 μm, 5-30 vol. % 10-20 μm, >10 vol % 20-50 μm and >20 vol % 50-100 μm;
(ii) 5.5 to 6.5 wt % expandable graphite, and
(iii) 1 to 1.3 wt % graphite having an aspect ratio of greater than 3, more preferably greater than 4;
based on the total weight of the adhesive.

In another preferred embodiment, the thermally conductive filler comprises:
(i) a mixture of aluminium trihydroxides having the following particle size distributions:
ATH1. a first aluminium trihydroxide having a particle size distribution as follows:
   D₁₀ 10 μm
   D₅₀ 8 μm
   D₉₀ 100 μm;
ATH2. a second aluminium trihydroxide having a particle size distribution as follows:
   D₅₀ 8 μm
   D₉₀ 18 μm;
(ii) expandable graphite that is a mixture of expandable graphites:
GR1. A first expandable graphite wherein 75 vol % has a particle size of <150 μm;
GR2. A second expandable graphite wherein 80 vol % has a particle size of >300 μm; and
(iii) graphite having an aspect ratio of greater than 3, more preferably greater than 4.

In a preferred embodiment, the adhesive resulting from mixing Component A and Component B comprises:
(i) 40 to 60 wt % aluminium trihydroxide having the following particle size distribution: 1-20 vol %<1 μm, 10-30 vol % 1-10 μm, 5-30 vol. % 10-20 μm, >10 vol % 20-50 μm and >20 vol % 50-100 μm;
(ii) 3 to 10 wt % expandable graphite, and
(iii) 0.5 to 3 wt % graphite having an aspect ratio of greater than 2 in the form of particles having a D₉₀ of 80-110 μm, more preferably 85-95 μm;
based on the total weight of the adhesive.

In another preferred embodiment, the adhesive resulting from mixing Component A and Component B comprises:
(i) 45 to 55 wt % aluminium trihydroxide having the following particle size distribution: 1-20 vol %<1 μm, 10-30 vol % 1-10 μm, 5-30 vol. % 10-20 μm, >10 vol % 20-50 μm and >20 vol % 50-100 μm;
(ii) 4 to 7 wt % expandable graphite, and
(iii) 0.75 to 1.5 wt % graphite having an aspect ratio of greater than 2 in the form of particles having a D₉₀ of 80-110 μm, more preferably 85-95 μm;
based on the total weight of the adhesive.

In another preferred embodiment, the adhesive resulting from mixing Component A and Component B comprises:
(i) 48 to 50 wt % aluminium trihydroxide having the following particle size distribution: 1-20 vol %<1 μm, 10-30 vol % 1-10 μm, 5-30 vol. % 10-20 μm, >10 vol % 20-50 μm and >20 vol % 50-100 μm;
(ii) 5.5 to 6.5 wt % expandable graphite, and
(iii) 1 to 1.3 wt % graphite having an aspect ratio of greater than 2 in the form of particles having a D₉₀ of 80-110 μm, more preferably 85-95 μm;
based on the total weight of the adhesive.

In another preferred embodiment, the thermally conductive filler comprises:
(i) a mixture of aluminium trihydroxides having the following particle size distributions:
ATH1. a first aluminium trihydroxide having a particle size distribution as follows:
   D₁₀ 10 μm
   D₅₀ 8 μm
   D₉₀ 100 μm;
ATH2. a second aluminium trihydroxide having a particle size distribution as follows:
   D₅₀ 8 μm
   D₉₀ 18 μm;
(ii) expandable graphite that is a mixture of expandable graphites:
GR1. A first expandable graphite wherein 75 vol % has a particle size of <150 μm;
GR2. A second expandable graphite wherein 80 vol % has a particle size of >300 μm; and
(iii) graphite having an aspect ratio of greater than 2 in the form of particles having a D₉₀ of 80-110 μm, more preferably 85-95 μm.

### Polyether Polyol (b1)

Component B comprises at least one polyether polyol. The at least one polyetherpolyol is preferably a diol, triol or tetra-ol. Preferably it is a diol, triol or a mixture of a triol and a diol, with mixtures of diols and triols being particularly preferred.

Polyether polyols are well-known in the art and include, for example, polyoxyethylene, polyoxypropylene, polyoxybutylene, and polytetramethylene ether diols and triols which may be prepared, for example, by reacting an unsubstituted or halogen- or aromatic-substituted ethylene oxide or propylene oxide with an initiator compound containing two or more active hydrogen groups such as water, ammonia, a polyalcohol, or an amine. In general, polyether polyols may be prepared by polymerizing alkylene oxides in the presence of an active hydrogen-containing initiator compound. Preferred polyether polyols contain one or more alkylene oxide units in the backbone of the polyol. Preferred alkylene oxide units are ethylene oxide, propylene oxide, butylene oxide and mixtures thereof. Preferably, the polyol contains propylene oxide units, ethylene oxide units or a mixture thereof. In the embodiment where a mixture of alkylene oxide units is contained in a polyol, the different units can be randomly arranged or can be arranged in blocks of each alkylene oxides. In one preferred embodiment, the polyol comprises propylene oxide chains. In a preferred embodiment, the polyether polyols are a mixture of polyether diols and polyether triols. Preferably, the polyether polyol or mixture has a functionality of at least about 2.0; and is preferably about 2.0 to 3.0 or greater, for example, 3.5, 4.0 or greater. Preferably, the equivalent weight of the polyether polyol mixture is from 80 to 1,200 g/eq.

More specific examples of polyether polyols include:
1. Difunctional polyols (diols), such as poly(alkylene oxide)diols, where the alkylene group is C2 to C4, particularly poly(ethylene oxide)diol, poly(propylene oxide)diol, poly(butylene oxide) diol and poly(tetramethylene oxide)diol, with poly(propylene oxide)diol being particularly preferred. In a particularly preferred embodiment the polyether polyol comprises a nominally difunctional, poly(propylene oxide) having an equivalent weight of from 80 to 2,500 g/eq, more preferably 200 to 1,100 g/eq;
2. Trifunctional polyols (triols), such as those based on the alkylene oxides initiated with a trifunctional polyol, such as trimethylolpropane, where the alkylene group is C2 to C4, particularly ethylene oxide, propylene oxide, butylene oxide, tetramethylene oxide and butylene oxide, with propylene oxide being particularly preferred. In a particularly preferred embodiment, the polyether polyol comprises a nominally trifunctional poly(propylene oxide) having an equivalent weight of from 80 to 2,500 g/eq, more preferably 80 to 90 g/eq; the polymer may or may not be capped with ethylene oxide to modify reactivity.
3. A mixture of 1 and 2. Particularly preferred is a mixture of 1 and 2, more particularly preferred is a mixture of a) a nominally difunctional, poly(propylene oxide) having an equivalent weight of from 100 to 2,500, more preferably 200 to 1,500, particularly preferably 200 to 1,000 and b) a nominally trifunctional poly(propylene oxide) and equivalent weight of 80 to 90.

In a particularly preferred embodiment, the at least one polyol comprises a mixture of propylene oxide based diols and triols.

In addition to the at least one polyetherpolyol, Component B may comprise additional polyols. In a preferred embodiment, Component B comprises a diol or triol having a molecular weight of less than 250 Da. Examples include 1,4-butane diol, 1,5-pentane diol and 1,6-hexane diol, with 1,4-butane diol being particularly preferred.

If used, the diol or triol having a molecular weight of less than 250 Da is preferably present at 2 to 10 wt %, more preferably 4 to 8 wt %, based on the total weight of Component B. In a preferred embodiment, Component B comprises butanediol at 2 to 10 wt %, more preferably 4 to 8 wt %, based on the total weight of Component B.

In a preferred embodiment, the at least one polyether polyol in Component B comprises a mixture of poly(propylene oxide) diols.

In another preferred embodiment, the at least one polyether polyol in Component B comprises a poly(propylene oxide) triol.

In a preferred embodiment, the at least one polyol in Component B comprises a poly(propylene oxide) triol having an average equivalent weight of 1602.8 g/eq.

Component B preferably comprises the polyether polyol (b1) at 30 to 45 wt %, more preferably 30 to 40 wt %, particularly preferably 35 to 38 wt %, based on the total weight of Component B.

In a preferred embodiment, Component B comprises at least one poly(propylene oxide) triol at 30 to 45 wt %, more preferably 30 to 40 wt %, particularly preferably 35 to 38 wt %, based on the total weight of Component B.

In another preferred embodiment, Component B comprises a poly(propylene oxide) triol having an average equivalent weight of 1602.8 g/eq at 30 to 45 wt %, more preferably 30 to 40 wt %, particularly preferably 35 to 38 wt %, based on the total weight of Component B.

In a particularly preferred embodiment, Component B comprises a poly(propylene oxide) triol and butane diol.

In another particularly preferred embodiment, Component B comprises 30 to 40 wt % of a poly(propylene oxide) triol, and 4 to 8 wt % butane diol, based on the total weight of Component B.

### Catalyst (b2)

Component B comprises a catalyst capable of catalysing the reaction of an NCO functionality with an OH functionality.

Examples of such catalysts include tertiary amine catalysts, organometallic catalysts, such as bismuth catalysts, alkyl tin carboxylates, oxides and tin mercaptides.

Specific examples of tertiary amine catalysts include N-methyl morpholine, N-methyl imidazole, triethylenediamine, bis-(2-dimethylaminoethyl)-ether, 1,4-diazabicyclo[2.2.2]octane (DABCO), dimethylcyclohexylamine, dimethylethanolamine, 2,2-dimorpholinyl-diethylether (DMDEE), N,N,N-dimethylaminopropyl hexahydrotriazine, dimethyltetrahydropyrimidine, tetramethylethylenediamine, dimethylcyclohexylamine, 2,2-N,N benzyldimethylamine, dimethylethanol amine, dimethylaminopropyl amine, Penta-dimethyl diethylene triamine, N,N,N′,N′-tetramethyl-1,6-hexanediamine, N,N′,N′-trimethylaminoethylpiperazine, 1,1′-[[3-(dimethylamino)propyl]imino]bispropan-2-ol, 1,3,5-tris[3-(dimethylamino)propyl]hexahydro-1,3,5-triazine, N—N-dimethyldipropylene triamine, N,N,N′-trimethylaminoethylethanolamine, with DMDEE being particularly preferred.

If an organometallic catalyst is used, it is any organometallic catalyst capable of catalyzing the reaction of isocyanate with a functional group having at least one reactive hydrogen. Examples include bismuth catalysts, metal carboxylates such as tin carboxylate and zinc carboxylate. Metal alkanoates include stannous octoate, bismuth octoate or bismuth neodecanoate.

Preferably the at least one organometallic catalyst is a bismuth catalyst or an organotin catalyst. Examples include dibutyltin dilaurate, dimethyl tin dineodecanoate, dimethyltin mercaptide, dimethyltin carboxylate, dimethyltin dioleate, dimethyltin dithioglycolate, dibutyltin mercaptide, dibutyltin bis(2-ethylhexyl thioglycolate), dibutyltin sulfide, dioctyltin dithioglycolate, dioctyltin mercaptide, dioctyltin dioctoate, dioctyltin dineodecanoate, dioctyltin dilaurate.

In a particularly preferred embodiment, it is a tin catalyst, particularly preferably dioctyltin mercaptide.

The catalyst is preferably used at 0.01 to 0.0.02 wt %, more preferably 0.015 wt %, based on the total weight of Component B.

In a preferred embodiment, the catalyst is dioctyl tin mercaptide, used at 0.01 to 0.02 wt % based on the total weight of Component B.

### Optional Ingredients

Component A and Component B may additionally comprise fillers in addition to the thermally conductive fillers, such as talc, fumed silica, carbon black, zeolites, molecular sieves and mixtures of these.

### Method of Manufacture

The adhesive compositions of the invention are made by mixing the ingredients of each Component separately, preferably under inert and dry conditions and/or under vacuum, until a homogenous mixture is obtained. Once Component A and B are mixed, they are stored in separate containers until use.

### Method of Use

In one aspect, the invention provides a method for adhering two or more substrates, comprising the steps:
(1) providing a thermally-conductive, two-component polyurethane adhesive comprising:
(A) a first component (isocyanate component), comprising:
   (a1) at least one polyisocyanate;
(B) a second component (polyol component), comprising:
   (b1) at least one polyetherpolyol; and
   (b2) at least one catalyst capable of catalyzing the reaction of a hydroxyl group with an isocyanate group;
wherein Component A and/or Component B comprise (a2, b3) thermally conductive filler which comprises:
   (i) aluminium trihydroxide having a multimodal (preferably bimodal) particle size distribution;
   (ii) expandable graphite, and
   (iii) graphene, and/or graphite having an aspect ratio greater than 2;
and wherein the concentration of thermally conductive filler in Component A and/or Component B is sufficient to yield a concentration of 40 to 80 wt % thermally conductive filler in the adhesive when Component A and Component B are mixed together to form the adhesive;
(2) mixing Component A and Component B to produce the adhesive;
(3) applying the adhesive to a first substrate;
(4) bringing a second substrate into adhesive contact with the first substrate;
(5) allowing the adhesive to cure.

As mentioned above, a preferred way of providing Components the adhesive of the invention is in airtight containers, such as airtight sealed tubes. The containers are opened immediately prior to use.

The adhesive composition of the invention may be applied by any application method, manually or with robotic equipment, including, for example, by spreading, application through a nozzle.

In a preferred embodiment one or both of the first and second substrates are selected from metal, in particular Ni-plated steel and/or aluminium. In another embodiment one or both of the first and second substrates are selected from metal, including e-coated aluminum, e-coated steel, laser treated metal surfaces, metal surfaces treated with plasma or flaming. Plasma pretreatment can comprise plasma processes, which further chemically modify or treat the surface, such as plasma plus. One of these plasma plus treatments include a silane functionalization of the metallic surface. Further substrates include coated metals and metal surfaces modified with functional foils. Coatings epoxy-based coating and acrylic coatings. Foils are predominantly PET based.

Curing begins as soon as Components A and B are mixed. Typical curing conditions are 3 to 7 days at 23° C.

### Effect of the Invention

The adhesives of the invention show a thermal conductivity, after curing for 7 days at 23° C., of at least 1 W/mK, more preferably at least 1.12 W/mK, more particularly preferably at least 1.16 W/mK, when measured in accordance with ASTM D5470.

The adhesives of the invention show acceptable lap shear strengths, and retain lap shear strength even on prolonged exposure to heat and humidity. The adhesives preferably show a lap shear strength, after curing from 7 days at 23° C. of 4 MPa or greater, more preferably 5 MPA or greater, when tested according to DIN 1465. The adhesives of the invention preferably retain at least 60% of the original lap shear strength after exposure to 100% humidity for seven days at 70° C.

### Applications

The properties of the adhesives of the invention make them particularly suited to applications in which good adhesion, good elongation and good thermal conductivity are required.

In a preferred embodiment, the adhesives of the invention are used to adhere battery assemblies, in particular the bonding of cooling units to the battery compartment or the direct bonding of the cooling unit to the battery pack.

### Particularly Preferred Embodiments

The following are particularly preferred embodiments of the adhesive compositions of the invention:
1. A thermally-conductive, two-component polyurethane adhesive comprising:
   (A) a first component (isocyanate component), comprising:
      (a1) at least one polyisocyanate;
   (B) a second component (polyol component), comprising:
      (b1) at least one polyetherpolyol; and
      (b2) at least one catalyst capable of catalyzing the reaction of a hydroxyl group with an isocyanate group;
   wherein Component A and/or Component B comprise (a2, b3) thermally conductive filler which comprises:
      (i) aluminium trihydroxide having a multimodal particle size distribution;
      (ii) expandable graphite, and
      (iii) graphene, and/or graphite having an aspect ratio greater than 2;
   and wherein the concentration of thermally conductive filler in Component A and/or Component B is sufficient to yield a concentration of 40 to 80 wt % thermally conductive filler in the adhesive when Component A and Component B are mixed together to form the adhesive.
2. A thermally-conductive, two-component polyurethane adhesive made by mixing a first component (A) and a second component (B) wherein the components comprise:
   (A) (a1) at least one polyisocyanate;
   (B) (b1) at least one polyetherpolyol; and
      (b2) at least one catalyst capable of catalyzing the reaction of a hydroxyl group with an isocyanate group;
   wherein Component A and/or Component B comprise (a2, b3) thermally conductive filler which comprises:
      (i) aluminium trihydroxide having a multimodal particle size distribution;
      (ii) expandable graphite, and
      (iii) graphene, and/or graphite having an aspect ratio greater than 2;
   and wherein the concentration of thermally conductive filler in Component A and/or Component B is sufficient to yield a concentration of 40 to 80 wt % thermally conductive filler in the adhesive when Component A and Component B are mixed together to form the adhesive.
3. A method for adhering two or more substrates, comprising the steps:
   (1) providing a thermally-conductive, two-component polyurethane adhesive comprising:
   (A) a first component (isocyanate component), comprising:
      (a1) at least one polyisocyanate;
   (B) a second component (polyol component), comprising:
      (b1) at least one polyetherpolyol; and
      (b2) at least one catalyst capable of catalyzing the reaction of a hydroxyl group with an isocyanate group;
   wherein Component A and/or Component B comprise (a2, b3) thermally conductive filler which comprises:
      (i) aluminium trihydroxide having a multimodal particle size distribution;
      (ii) expandable graphite, and
      (iii) graphene, and/or graphite having an aspect ratio greater than 2;
   and wherein the concentration of thermally conductive filler in Component A and/or Component B is sufficient to yield a concentration of 40 to 80 wt % thermally conductive filler in the adhesive when Component A and Component B are mixed together to form the adhesive;
   (2) mixing Component A and Component B to produce the adhesive;
   (3) applying the adhesive to a first substrate;
   (4) bringing a second substrate into adhesive contact with the first substrate;
   (5) allowing the adhesive to cure.
4. An adhered structure, comprising:
   (1) a first substrate;
   (2) a second substrate adhesively bonded to the first substrate by a cured adhesive;
   wherein the cured adhesive results from curing a mixture of a first component (A) and a second component (B), wherein the components comprise:
   (A) (a1) at least one polyisocyanate;
   (B) (b1) at least one polyetherpolyol; and
      (b2) at least one catalyst capable of catalyzing the reaction of a hydroxyl group with an isocyanate group;
   wherein Component A and/or Component B comprise (a2, b3) thermally conductive filler which comprises:
      (i) aluminium trihydroxide having a multimodal particle size distribution;
      (ii) expandable graphite, and
      (iii) graphene, and/or graphite having an aspect ratio greater than 2;
   and wherein the concentration of thermally conductive filler in Component A and/or Component B is sufficient to yield a concentration of 40 to 80 wt % thermally conductive filler in the adhesive when Component A and Component B are mixed together to form the adhesive.
5. Any one preceding embodiment, wherein the at least one polyisocyanate has an average NCO functionality of greater than 2.
6. Any one preceding embodiment, wherein the at least one polyisocyanate has an average NCO functionality of greater than 2.1.
7. Any one preceding embodiment, wherein the at least one polyisocyanate has an average NCO functionality of greater than 2.15.
8. Any one preceding embodiment, wherein the at least on polyisocyanate is a prepolymer which is formed by reaction of at least one molecule bearing two or more isocyanate groups with a polyol, such that the terminal groups are isocyanate groups.
9. Any one preceding embodiment, wherein the polyisocyanate is a prepolymer which is formed by reaction of at least one molecule bearing two or more isocyanate groups with a polyether polyol, such that the terminal groups are isocyanate groups.
10. Any one preceding embodiment, wherein the polyisocyanate is a prepolymer which is formed by reaction of at least one molecule bearing two or more isocyanate groups, having an average NCO functionality of greater than 2, more preferably 2.1 or greater, more particularly preferably 2.15 or greater, with a polyether polyol, such that the terminal groups are isocyanate groups.
11. Any one preceding embodiment, wherein the polyisocyanate is a prepolymer which is formed by reaction of at least one molecule bearing two or more isocyanate groups with a poly(propylene oxide)-based polyol, such that the terminal groups are isocyanate groups.
12. Any one preceding embodiment, wherein the polyisocyanate is a prepolymer which is formed by reaction of at least one molecule bearing two or more isocyanate groups with a poly(propylene oxide)-based diol, such that the terminal groups are isocyanate groups.
13. Any one preceding embodiment, wherein the polyisocyanate is a prepolymer formed by reaction MDI with a polyether polyol.
14. Any one preceding embodiment, wherein the polyisocyanate is a prepolymer formed by reaction MDI with a poly(propylene oxide)-based polyol.
15. Any one preceding embodiment, wherein the polyisocyanate is a prepolymer formed by reaction MDI with a poly(propylene oxide)-based diol.
16. Any one preceding embodiment, wherein the polyisocyanate is a prepolymer formed by reaction MDI with a first poly(propylene oxide)-based diol having an equivalent weight of 700 g/eq or greater and a second poly(propylene oxide)-based diol having an equivalent weight of 500 g/eq or less.
17. Any one preceding embodiment, wherein the polyisocyanate is a prepolymer formed by reaction MDI with a first poly(propylene oxide)-based diol having an equivalent weight of 1001 g/eq and a second poly(propylene oxide)-based diol having an equivalent weight of 215 g/eq.
18. Any one preceding embodiment, wherein the polyisocyanate is a prepolymer having an average NCO functionality of greater than 2.0, more preferably 2.1 or greater, more particularly preferably 2.15 or greater.
19. Any one preceding embodiment, wherein the prepolymer is made by reacting MDI and/or polymeric MDI with a poly(propylene oxide)-based diol, such that the prepolymer has an average NCO content of greater than 2.0, more preferably 2.1 or greater, more particularly preferably 2.15 or greater.
20. Any one preceding embodiment, wherein the polyisocyanate is a prepolymer formed by reaction of a polyisocyanate and a polyol, comprising:
65-85 wt % polyisocyanate and 15-35 wt % polyol. More preferably, the prepolymer comprises 70-80 wt % polyisocyanate and 20-30 wt % polyol, based on the total weight of the prepolymer.
21. Any one preceding embodiment, wherein the polyisocyanate is a prepolymer formed by reaction of 65-85 wt % MDI and 15-35 wt % poly(propylene oxide)-based diol.
22. Any one preceding embodiment, wherein the polyisocyanate is a prepolymer which has a content of urethane groups (“hard segment”) that is greater than 20 wt %, more preferably greater than 29 wt %, more particularly preferably greater than 35 wt %, based on the total weight of the prepolymer. The hard segment content is calculated by summing the weight of aromatic MDI and polymeric MDI used to make the prepolymer, and calculating the wt % based on the total weight of the isocyanate component.
23. Any one preceding embodiment, wherein fully cured adhesive has a hard segment content that is greater than 10 wt %, more preferably greater than 20 wt %, and particularly preferably greater than 25 wt %.
24. Any one preceding embodiment, wherein the thermally conductive filler is present in Component A or Component B or both, and the concentration of thermally conductive filler in Component A and/or Component B is sufficient to yield a concentration of 40 to 80 wt %, more preferably 40 to 60 wt % thermally conductive filler in the adhesive, based on the total weight of the adhesive, when Component A and Component B are mixed together to form the adhesive.
25. Any one preceding embodiment, wherein the thermally conductive filler is present in Component A at 40 to 80 wt %, more preferably 40 to 60 wt %, based on the total weight of Component A.
26. Any one preceding embodiment, wherein the thermally conductive filler is present in Component B at 40 to 80 wt %, more preferably 40 to 60 wt %, based on the total weight of Component B.
27. Any one preceding embodiment, wherein the thermally conductive filler is present in Component A at 40 to 80 wt %, more preferably 40 to 60 wt %, based on the total weight of Component A, and the thermally conductive filler is present in Component B at 40 to 80 wt %, more preferably 40 to 60 wt %, based on the total weight of Component B.
28. Any one preceding embodiment, wherein the thermally conductive filler is present in the final adhesive at a concentration that gives a thermal conductivity of at or about 1.1 W/mK or more, after curing for 7 days at 23° C.
29. Any one preceding embodiment, wherein Component A and Component B are designed to be mixed in a volumetric ratio of 1:1, the concentration of the thermally conductive filler in Component A is from 40 to 80 wt %, more preferably 50 to 60 wt %, based on the total weight of Component A.
30. Any one preceding embodiment, wherein the aluminium trihydroxide has a bimodal particle size distribution.
31. Any one preceding embodiment, wherein the aluminium trihydroxide has the following particle size distribution:
   1-20 vol %<1 μm, 10-30 vol % 1-10 μm, 5-30 vol. % 10-20 μm, >10 vol % 20-50 μm and >20 vol % 50-100 μm.
32. Any one preceding embodiment, wherein the aluminium trihydroxide has the following particle size distribution:
   1-10 vol %<1 μm, 5-20 vol % 1-10 μm, 6-20 vol % 10-20 μm, 5-40 vol % 20-50 μm and 35-60 vol % 50-100 μm.
33. Any one preceding embodiment, wherein the aluminium trihydroxide has the following particle size distribution:
   1-5 vol %<1 μm, 5-15 vol % 1-10 μm, 6-15 vol % 10-20 μm, 20-40 vol % 20-50 μm and 40-70 vol % 50-100 μm.
34. Any one preceding embodiment, wherein the aluminum trihydroxide comprises a mixture of aluminium trihydroxides having the following particle size distributions:
   ATH1. a first aluminium trihydroxide having a particle size distribution as follows:
      D₁₀ 10 μm
      D₅₀ 8 μm
      D₉₀ 100 μm;
   ATH2. a second aluminium trihydroxide having a particle size distribution as follows:
      D₅₀ 8 μm
      D₉₀ 18 μm.
35. Embodiment 30, wherein the aluminium trihydroxide comprises 75 to 90 wt %, more preferably 80 to 90 wt %, particularly preferably 85 to 88 wt % ATH1 and 10 to 25 wt %, more preferably 10 to 20 wt %, particularly preferably 12 to 15 wt % ATH2, based on the total weight of aluminium trihydroxide.
36. Any one preceding embodiment, wherein the total amount of aluminium trihydroxide in Component A and/or Component B is preferably 40 to 60 wt %, more preferably 45 to 55 wt %, particularly preferably 47 to 52 wt %, based on the total weight of the relevant Component.
37. Any one preceding embodiment, wherein the expandable graphite has a particle size distribution as follows: 1-10 vol % larger than 50 μm, 20-50 vol % larger than 150 μm and 30-80 vol % larger than 300 μm.
38. Any one preceding embodiment, wherein the expandable graphite is a mixture of expandable graphites:
   GR1. A first expandable graphite wherein 75 vol % has a particle size of <150 μm.
   GR2. A second expandable graphite wherein 80 vol % has a particle size of >300 μm.
39. Embodiment 38, wherein the expandable graphite comprises 40 to 80 wt %, more preferably 45 to 75 wt %, particularly preferably 50 to 75 wt % GR1, and 20 to 60 wt %, more preferably 25 to 55 wt %, particularly preferably 25 to 50 wt % GR2, based on the total weight of expandable graphite.
40. Any one preceding embodiment, wherein the total amount of expandable graphite in Component A and/or Component B is preferably 2 to 10 wt %, more preferably 4 to 8 wt %, particularly preferably 6 wt %, based on the total weight of the relevant Component.
41. Any one preceding embodiment, wherein the graphene has a volume average platelet size of from 10 to 30 μm, more preferably 20-30 μm, particularly preferably 24 to 26 μm.
42. Any one preceding embodiment, wherein the amount of graphene, and/or graphite having an aspect ratio greater than 2 in Component A and/or Component B is 0.5 to 2 wt %, more preferably 0.75 to 1.5 wt %, particularly preferably 1 to 1.3 wt %, based on the total weight of the relevant component.
43. Any one preceding embodiment, wherein In a preferred embodiment, the thermally conductive filler comprises:
   (i) 75 to 95 wt % aluminium trihydroxide having a multimodal (preferably bimodal) particle size distribution;
   (ii) 5 to 15 wt % expandable graphite, and
   (iii) 0.5 to 4 wt % graphene, and/or graphite having an aspect ratio greater than 2,
   wherein the wt %'s are based on the total weight of thermally conductive filler.
44. Any one preceding embodiment, wherein the thermally conductive filler comprises:
   (i) 80 to 90 wt % aluminium trihydroxide having a multimodal (preferably bimodal) particle size distribution;
   (ii) 7 to 12 wt % expandable graphite, and
   (iii) 1 to 3 wt % graphene, and/or graphite having an aspect ratio greater than 2,
   wherein the wt %'s are based on the total weight of thermally conductive filler.
45. Any one preceding embodiment, wherein the thermally conductive filler comprises:
   (i) 85 to 88 wt % aluminium trihydroxide having a multimodal (preferably bimodal) particle size distribution;
   (ii) 9 to 11 wt % expandable graphite, and
   (iii) 1.5 to 2.5 wt % graphene, and/or graphite having an aspect ratio greater than 2,
   wherein the wt %'s are based on the total weight of thermally conductive filler.
46. Any one preceding embodiment, wherein the thermally conductive filler comprises:
   (i) 75 to 95 wt % aluminium trihydroxide having a multimodal (preferably bimodal) particle size distribution;
   (ii) 5 to 15 wt % expandable graphite, having the following particle size distribution 1-10 vol % larger than 50 μm, 20-50 vol % larger than 150 μm and 30-80 vol % larger than 300 μm, and
   (iii) 0.5 to 4 wt % graphene, and/or graphite having an aspect ratio greater than 2,
   wherein the wt %'s are based on the total weight of thermally conductive filler.
47. Any one preceding embodiment, wherein the thermally conductive filler comprises:
   (i) 80 to 90 wt % aluminium trihydroxide having a multimodal (preferably bimodal) particle size distribution;
   (ii) 7 to 12 wt % expandable graphite, having the following particle size distribution 1-10 vol % larger than 50 μm, 20-50 vol % larger than 150 μm and 30-80 vol % larger than 300 μm, and
   (iii) 1 to 3 wt % graphene, and/or graphite having an aspect ratio greater than 2,
   wherein the wt %'s are based on the total weight of thermally conductive filler.
48. Any one preceding embodiment, wherein the thermally conductive filler comprises:
   (i) 85 to 88 wt % aluminium trihydroxide having a multimodal (preferably bimodal) particle size distribution;
   (ii) 9 to 11 wt % expandable graphite, having the following particle size distribution 1-10 vol % larger than 50 μm, 20-50 vol % larger than 150 μm and 30-80 vol % larger than 300 μm, and
   (iii) 1.5 to 2.5 wt % graphene, and/or graphite having an aspect ratio greater than 2,
   wherein the wt %'s are based on the total weight of thermally conductive filler.
49. Any one preceding embodiment, wherein the thermally conductive filler comprises:
   (i) 75 to 95 wt % aluminium trihydroxide having a multimodal (preferably bimodal) particle size distribution;
   (ii) 5 to 15 wt % expandable graphite which is a mixture of expandable graphites:
   GR1. A first expandable graphite wherein 75 vol % has a particle size of <150 μm;
   GR2. A second expandable graphite wherein 80 vol % has a particle size of >300 μm; and
   (iii) 0.5 to 4 wt % graphene, and/or graphite having an aspect ratio greater than 2,
   wherein the wt %'s are based on the total weight of thermally conductive filler.
50. Any one preceding embodiment, wherein the thermally conductive filler comprises:
   (i) 80 to 90 wt % aluminium trihydroxide having a multimodal (preferably bimodal) particle size distribution;
   (ii) 7 to 12 wt % expandable graphite which is a mixture of expandable graphites:
   GR1. A first expandable graphite wherein 75 vol % has a particle size of <150 μm;
   GR2. A second expandable graphite wherein 80 vol % has a particle size of >300 μm; and
   (iii) 1 to 3 wt % graphene, and/or graphite having an aspect ratio greater than 2,
   wherein the wt %'s are based on the total weight of thermally conductive filler.
51. Any one preceding embodiment, wherein the thermally conductive filler comprises:
   (i) 85 to 88 wt % aluminium trihydroxide having a multimodal (preferably bimodal) particle size distribution;
   (ii) 9 to 11 wt % expandable graphite which is a mixture of expandable graphites:
   GR1. A first expandable graphite wherein 75 vol % has a particle size of <150 μm;
   GR2. A second expandable graphite wherein 80 vol % has a particle size of >300 μm; and
   (iii) 1.5 to 2.5 wt % graphene, and/or graphite having an aspect ratio greater than 2,
   wherein the wt %'s are based on the total weight of thermally conductive filler.
52. Any one preceding embodiment, wherein the thermally conductive filler comprises:
   (i) 75 to 95 wt % aluminium trihydroxide having a multimodal (preferably bimodal) particle size distribution;
   (ii) 5 to 15 wt % expandable graphite, and
   (iii) 0.5 to 4 wt % graphene, having a volume average platelet size of from 10 to 30 μm, more preferably 20-30 μm, particularly preferably 24 to 26 μm;
   wherein the wt %'s are based on the total weight of thermally conductive filler.
53. Any one preceding embodiment, wherein the thermally conductive filler comprises:
   (i) 80 to 90 wt % aluminium trihydroxide having a multimodal (preferably bimodal) particle size distribution;
   (ii) 7 to 12 wt % expandable graphite, and
   (iii) 1 to 3 wt % graphene, having a volume average platelet size of from
   10 to 30 μm, more preferably 20-30 μm, particularly preferably 24 to 26 μm;
   wherein the wt %'s are based on the total weight of thermally conductive filler.
54. Any one preceding embodiment, wherein the thermally conductive filler comprises:
   (i) 85 to 88 wt % aluminium trihydroxide having a multimodal (preferably bimodal) particle size distribution;
   (ii) 9 to 11 wt % expandable graphite, and
   (iii) 1.5 to 2.5 wt % graphene, having a volume average platelet size of from 10 to 30 μm, more preferably 20-30 μm, particularly preferably 24 to 26 μm;
   wherein the wt %'s are based on the total weight of thermally conductive filler.
55. Any one preceding embodiment, wherein the adhesive resulting from mixing Component A and Component B comprises:
   (i) 40 to 60 wt % aluminium trihydroxide having a multimodal (preferably bimodal) particle size distribution;
   (ii) 3 to 10 wt % expandable graphite, and
   (iii) 0.5 to 3 wt % graphene, and/or graphite having an aspect ratio greater than 2,
   based on the total weight of the adhesive.
56. Any one preceding embodiment, wherein the adhesive resulting from mixing Component A and Component B comprises:
   (i) 45 to 55 wt % aluminium trihydroxide having a multimodal (preferably bimodal) particle size distribution;
   (ii) 4 to 7 wt % expandable graphite, and
   (iii) 0.75 to 1.5 wt % graphene, and/or graphite having an aspect ratio greater than 2,
   based on the total weight of the adhesive.
57. Any one preceding embodiment, wherein the adhesive resulting from mixing Component A and Component B comprises:
   (i) 48 to 50 wt % aluminium trihydroxide having a multimodal (preferably bimodal) particle size distribution;
   (ii) 5.5 to 6.5 wt % expandable graphite, and
   (iii) 1 to 1.3 wt % graphene, and/or graphite having an aspect ratio greater than 2,
   based on the total weight of the adhesive.
58. Any one preceding embodiment, wherein the adhesive resulting from mixing Component A and Component B comprises:
   (i) 40 to 60 wt % aluminium trihydroxide having a multimodal (preferably bimodal) particle size distribution;
   (ii) 3 to 10 wt % expandable graphite, having the following particle size distribution 1-10 vol % larger than 50 μm, 20-50 vol % larger than 150 μm and 30-80 vol % larger than 300 μm, and
   (iii) 0.5 to 3 wt % graphene, and/or graphite having an aspect ratio greater than 2,
   based on the total weight of the adhesive.
59. Any one preceding embodiment, wherein the adhesive resulting from mixing Component A and Component B comprises:
   (i) 45 to 55 wt % aluminium trihydroxide having a multimodal (preferably bimodal) particle size distribution;
   (ii) 4 to 7 wt % expandable graphite, having the following particle size distribution 1-10 vol % larger than 50 μm, 20-50 vol % larger than 150 μm and 30-80 vol % larger than 300 μm, and
   (iii) 0.75 to 1.5 wt % graphene, and/or graphite having an aspect ratio greater than 2,
   based on the total weight of the adhesive.
60. Any one preceding embodiment, wherein the adhesive resulting from mixing Component A and Component B comprises:
   (i) 48 to 50 wt % aluminium trihydroxide having a multimodal (preferably bimodal) particle size distribution;
   (ii) 5.5 to 6.5 wt % expandable graphite, having the following particle size distribution 1-10 vol % larger than 50 μm, 20-50 vol % larger than 150 μm and 30-80 vol % larger than 300 μm, and
   (iii) 1 to 1.3 wt % graphene, and/or graphite having an aspect ratio greater than 2,
   based on the total weight of the adhesive.
61. Any one preceding embodiment, wherein the adhesive resulting from mixing Component A and Component B comprises:
   (i) 40 to 60 wt % aluminium trihydroxide having a multimodal (preferably bimodal) particle size distribution;
   (ii) 3 to 10 wt % expandable graphite, and
   (iii) 0.5 to 3 wt % graphene, having a volume average platelet size of from 10 to 30 μm, more preferably 20-30 μm, particularly preferably 24 to 26 μm;
   based on the total weight of the adhesive.
62. Any one preceding embodiment, wherein the adhesive resulting from mixing Component A and Component B comprises:
   (i) 45 to 55 wt % aluminium trihydroxide having a multimodal (preferably bimodal) particle size distribution;
   (ii) 4 to 7 wt % expandable graphite, and
   (iii) 0.75 to 1.5 wt % graphene, having a volume average platelet size of from 10 to 30 μm, more preferably 20-30 μm, particularly preferably 24 to 26 μm;
   based on the total weight of the adhesive.
63. Any one preceding embodiment, wherein the adhesive resulting from mixing Component A and Component B comprises:
   (i) 48 to 50 wt % aluminium trihydroxide having a multimodal (preferably bimodal) particle size distribution;
   (ii) 5.5 to 6.5 wt % expandable graphite, and
   (iii) 1 to 1.3 wt % graphene, having a volume average platelet size of from 10 to 30 μm, more preferably 20-30 μm, particularly preferably 24 to 26 μm;
   based on the total weight of the adhesive.
64. Any one preceding embodiment, wherein In a preferred embodiment, the thermally conductive filler comprises:
   (i) 75 to 95 wt % aluminium trihydroxide having the following particle size distribution: 1-20 vol %<1 μm, 10-30 vol % 1-10 μm, 5-30 vol. % 10-20 μm, >10 vol % 20-50 μm and >20 vol % 50-100 μm;
   (ii) 5 to 15 wt % expandable graphite, and
   (iii) 0.5 to 4 wt % graphene, and/or graphite having an aspect ratio greater than 2,
   wherein the wt %'s are based on the total weight of thermally conductive filler.
65. Any one preceding embodiment, wherein the thermally conductive filler comprises:
   (i) 80 to 90 wt % aluminium trihydroxide having the following particle In another preferred embodiment, the thermally conductive filler comprises:
   (i) 80 to 90 wt % aluminium trihydroxide having the following particle size distribution: 1-20 vol %<1 μm, 10-30 vol % 1-10 μm, 5-30 vol. % 10-20 μm, >10 vol % 20-50 μm and >20 vol % 50-100 μm;
   (ii) 7 to 12 wt % expandable graphite, and
   (iii) 1 to 3 wt % graphene, and/or graphite having an aspect ratio greater than 2,
   wherein the wt %'s are based on the total weight of thermally conductive filler.
66. Any one preceding embodiment, wherein the thermally conductive filler comprises:
   (i) 85 to 88 wt % aluminium trihydroxide having the following particle size distribution: 1-20 vol %<1 μm, 10-30 vol % 1-10 μm, 5-30 vol. % 10-20 μm, >10 vol % 20-50 μm and >20 vol % 50-100 μm;
   (ii) 9 to 11 wt % expandable graphite, and
   (iii) 1.5 to 2.5 wt % graphene, and/or graphite having an aspect ratio greater than 2,
   wherein the wt %'s are based on the total weight of thermally conductive filler.
67. Any one preceding embodiment, wherein the thermally conductive filler comprises:
   (i) 75 to 95 wt % aluminium trihydroxide having the following particle size distribution: 1-20 vol %<1 μm, 10-30 vol % 1-10 μm, 5-30 vol. % 10-20 μm, >10 vol % 20-50 μm and >20 vol % 50-100 μm;
   (ii) 5 to 15 wt % expandable graphite, having the following particle size distribution 1-10 vol % larger than 50 μm, 20-50 vol % larger than 150 μm and 30-80 vol % larger than 300 μm, and
   (iii) 0.5 to 4 wt % graphene, and/or graphite having an aspect ratio greater than 2,
   wherein the wt %'s are based on the total weight of thermally conductive filler.
68. Any one preceding embodiment, wherein the thermally conductive filler comprises:
   (i) 80 to 90 wt % aluminium trihydroxide having the following particle size distribution: 1-20 vol %<1 μm, 10-30 vol % 1-10 μm, 5-30 vol. % 10-20 μm, >10 vol % 20-50 μm and >20 vol % 50-100 μm;
   (ii) 7 to 12 wt % expandable graphite, having the following particle size distribution 1-10 vol % larger than 50 μm, 20-50 vol % larger than 150 μm and 30-80 vol % larger than 300 μm, and
   (iii) 1 to 3 wt % graphene, and/or graphite having an aspect ratio greater than 2,
   wherein the wt %'s are based on the total weight of thermally conductive filler.
69. Any one preceding embodiment, wherein the thermally conductive filler comprises:
   (i) 85 to 88 wt % aluminium trihydroxide having the following particle size distribution: 1-20 vol %<1 μm, 10-30 vol % 1-10 μm, 5-30 vol. % 10-20 μm, >10 vol % 20-50 μm and >20 vol % 50-100 μm;
   (ii) 9 to 11 wt % expandable graphite, having the following particle size distribution 1-10 vol % larger than 50 μm, 20-50 vol % larger than 150 μm and 30-80 vol % larger than 300 μm, and
   (iii) 1.5 to 2.5 wt % graphene, and/or graphite having an aspect ratio greater than 2,
   wherein the wt %'s are based on the total weight of thermally conductive filler.
70. Any one preceding embodiment, wherein the thermally conductive filler comprises:
   (i) 75 to 95 wt % aluminium trihydroxide having the following particle size distribution: 1-20 vol %<1 μm, 10-30 vol % 1-10 μm, 5-30 vol. % 10-20 μm, >10 vol % 20-50 μm and >20 vol % 50-100 μm;
   (ii) 5 to 15 wt % expandable graphite which is a mixture of expandable graphites:
   GR1. A first expandable graphite wherein 75 vol % has a particle size of <150 μm;
   GR2. A second expandable graphite wherein 80 vol % has a particle size of >300 μm; and
   (iii) 0.5 to 4 wt % graphene, and/or graphite having an aspect ratio greater than 2,
   wherein the wt %'s are based on the total weight of thermally conductive filler.
71. Any one preceding embodiment, wherein the thermally conductive filler comprises:
   (i) 80 to 90 wt % aluminium trihydroxide having the following particle size distribution: 1-20 vol %<1 μm, 10-30 vol % 1-10 μm, 5-30 vol. % 10-20 μm, >10 vol % 20-50 μm and >20 vol % 50-100 μm;
   (ii) 7 to 12 wt % expandable graphite which is a mixture of expandable graphites:
   GR1. A first expandable graphite wherein 75 vol % has a particle size of <150 μm;
   GR2. A second expandable graphite wherein 80 vol % has a particle size of >300 μm; and
   (iii) 1 to 3 wt % graphene, and/or graphite having an aspect ratio greater than 2,
   wherein the wt %'s are based on the total weight of thermally conductive filler.
72. Any one preceding embodiment, wherein the thermally conductive filler comprises:
   (i) 85 to 88 wt % aluminium trihydroxide having the following particle size distribution: 1-20 vol %<1 μm, 10-30 vol % 1-10 μm, 5-30 vol. % 10-20 μm, >10 vol % 20-50 μm and >20 vol % 50-100 μm;
   (ii) 9 to 11 wt % expandable graphite which is a mixture of expandable graphites:
   GR1. A first expandable graphite wherein 75 vol % has a particle size of <150 μm;
   GR2. A second expandable graphite wherein 80 vol % has a particle size of >300 μm; and
   (iii) 1.5 to 2.5 wt % graphene, and/or graphite having an aspect ratio greater than 2,
   wherein the wt %'s are based on the total weight of thermally conductive filler.
73. Any one preceding embodiment, wherein the thermally conductive filler comprises:
   (i) 75 to 95 wt % aluminium trihydroxide having the following particle size distribution: 1-20 vol %<1 μm, 10-30 vol % 1-10 μm, 5-30 vol. % 10-20 μm, >10 vol % 20-50 μm and >20 vol % 50-100 μm;
   (ii) 5 to 15 wt % expandable graphite, and
   (iii) 0.5 to 4 wt % graphene, having a volume average platelet size of from 10 to 30 μm, more preferably 20-30 μm, particularly preferably 24 to 26 μm;
   wherein the wt %'s are based on the total weight of thermally conductive filler.
74. Any one preceding embodiment, wherein the thermally conductive filler comprises:
   (i) 80 to 90 wt % aluminium trihydroxide having the following particle size distribution: 1-20 vol %<1 μm, 10-30 vol % 1-10 μm, 5-30 vol. % 10-20 μm, >10 vol % 20-50 μm and >20 vol % 50-100 μm;
   (ii) 7 to 12 wt % expandable graphite, and
   (iii) 1 to 3 wt % graphene, having a volume average platelet size of from 10 to 30 μm, more preferably 20-30 μm, particularly preferably 24 to 26 μm;
   wherein the wt %'s are based on the total weight of thermally conductive filler.
75. Any one preceding embodiment, wherein the thermally conductive filler comprises:
   (i) 85 to 88 wt % aluminium trihydroxide having the following particle size distribution: 1-20 vol %<1 μm, 10-30 vol % 1-10 μm, 5-30 vol. % 10-20 μm, >10 vol % 20-50 μm and >20 vol % 50-100 μm;
   (ii) 9 to 11 wt % expandable graphite, and
   (iii) 1.5 to 2.5 wt % graphene, having a volume average platelet size of from 10 to 30 μm, more preferably 20-30 μm, particularly preferably 24 to 26 μm;
   wherein the wt %'s are based on the total weight of thermally conductive filler.
76. Any one preceding embodiment, wherein the adhesive resulting from mixing Component A and Component B comprises:
   (i) 40 to 60 wt % aluminium trihydroxide having the following particle size distribution: 1-20 vol %<1 μm, 10-30 vol % 1-10 μm, 5-30 vol. % 10-20 μm, >10 vol % 20-50 μm and >20 vol % 50-100 μm;
   (ii) 3 to 10 wt % expandable graphite, and
   (iii) 0.5 to 3 wt % graphene, and/or graphite having an aspect ratio greater than 2,
   based on the total weight of the adhesive.
77. Any one preceding embodiment, wherein the adhesive resulting from mixing Component A and Component B comprises:
   (i) 45 to 55 wt % aluminium trihydroxide having the following particle size distribution: 1-20 vol %<1 μm, 10-30 vol % 1-10 μm, 5-30 vol. % 10-20 μm, >10 vol % 20-50 μm and >20 vol % 50-100 μm;
   (ii) 4 to 7 wt % expandable graphite, and
   (iii) 0.75 to 1.5 wt % graphene, and/or graphite having an aspect ratio greater than 2,
   based on the total weight of the adhesive.
78. Any one preceding embodiment, wherein the adhesive resulting from mixing Component A and Component B comprises:
   (i) 48 to 50 wt % aluminium trihydroxide having the following particle size distribution: 1-20 vol %<1 μm, 10-30 vol % 1-10 μm, 5-30 vol. % 10-20 μm, >10 vol % 20-50 μm and >20 vol % 50-100 μm;
   (ii) 5.5 to 6.5 wt % expandable graphite, and
   (iii) 1 to 1.3 wt % graphene, and/or graphite having an aspect ratio greater than 2,
   based on the total weight of the adhesive.
79. Any one preceding embodiment, wherein the adhesive resulting from mixing Component A and Component B comprises:
   (i) 40 to 60 wt % aluminium trihydroxide having the following particle size distribution: 1-20 vol %<1 μm, 10-30 vol % 1-10 μm, 5-30 vol. % 10-20 μm, >10 vol % 20-50 μm and >20 vol % 50-100 μm;
   (ii) 3 to 10 wt % expandable graphite, having the following particle size distribution 1-10 vol % larger than 50 μm, 20-50 vol % larger than 150 μm and 30-80 vol % larger than 300 μm, and
   (iii) 0.5 to 3 wt % graphene, and/or graphite having an aspect ratio greater than 2,
   based on the total weight of the adhesive.
80. Any one preceding embodiment, wherein the adhesive resulting from mixing Component A and Component B comprises:
   (i) 45 to 55 wt % aluminium trihydroxide having the following particle size distribution: 1-20 vol %<1 μm, 10-30 vol % 1-10 μm, 5-30 vol. % 10-20 μm, >10 vol % 20-50 μm and >20 vol % 50-100 μm;
   (ii) 4 to 7 wt % expandable graphite, having the following particle size distribution 1-10 vol % larger than 50 μm, 20-50 vol % larger than 150 μm and 30-80 vol % larger than 300 μm, and
   (iii) 0.75 to 1.5 wt % graphene, and/or graphite having an aspect ratio greater than 2,
   based on the total weight of the adhesive.
81. Any one preceding embodiment, wherein the adhesive resulting from mixing Component A and Component B comprises:
   (i) 48 to 50 wt % aluminium trihydroxide having the following particle size distribution: 1-20 vol %<1 μm, 10-30 vol % 1-10 μm, 5-30 vol. % 10-20 μm, >10 vol % 20-50 μm and >20 vol % 50-100 μm;
   (ii) 5.5 to 6.5 wt % expandable graphite, having the following particle size distribution 1-10 vol % larger than 50 μm, 20-50 vol % larger than 150 μm and 30-80 vol % larger than 300 μm, and
   (iii) 1 to 1.3 wt % graphene, and/or graphite having an aspect ratio greater than 2,
   based on the total weight of the adhesive.
82. Any one preceding embodiment, wherein the adhesive resulting from mixing Component A and Component B comprises:
   (i) 40 to 60 wt % aluminium trihydroxide having the following particle size distribution: 1-20 vol %<1 μm, 10-30 vol % 1-10 μm, 5-30 vol. % 10-20 μm, >10 vol % 20-50 μm and >20 vol % 50-100 μm;
   (ii) 3 to 10 wt % expandable graphite, and
   (iii) 0.5 to 3 wt % graphene, having a volume average platelet size of from 10 to 30 μm, more preferably 20-30 μm, particularly preferably 24 to 26 μm;
   based on the total weight of the adhesive.
83. Any one preceding embodiment, wherein the adhesive resulting from mixing Component A and Component B comprises:
   (i) 45 to 55 wt % aluminium trihydroxide having the following particle size distribution: 1-20 vol %<1 μm, 10-30 vol % 1-10 μm, 5-30 vol. % 10-20 μm, >10 vol % 20-50 μm and >20 vol % 50-100 μm;
   (ii) 4 to 7 wt % expandable graphite, and
   (iii) 0.75 to 1.5 wt % graphene, having a volume average platelet size of from 10 to 30 μm, more preferably 20-30 μm, particularly preferably 24 to 26 μm;
   based on the total weight of the adhesive.
84. Any one preceding embodiment, wherein the adhesive resulting from mixing Component A and Component B comprises:
   (i) 48 to 50 wt % aluminium trihydroxide having the following particle size distribution: 1-20 vol %<1 μm, 10-30 vol % 1-10 μm, 5-30 vol. % 10-20 μm, >10 vol % 20-50 μm and >20 vol % 50-100 μm;
   (ii) 5.5 to 6.5 wt % expandable graphite, and
   (iii) 1 to 1.3 wt % graphene, having a volume average platelet size of from 10 to 30 μm, more preferably 20-30 μm, particularly preferably 24 to 26 μm;
   based on the total weight of the adhesive.
85. Any one preceding embodiment, wherein the thermally conductive filler comprises:
   (i) a mixture of aluminium trihydroxides having the following particle size distributions:
   ATH1. a first aluminium trihydroxide having a particle size distribution as follows:
      D₁₀ 10 μm
      D₅₀ 8 μm
      D₉₀ 100 μm;
   ATH2. a second aluminium trihydroxide having a particle size distribution as follows:
      D₅₀ 8 μm
      D₉₀ 18 μm;
   (ii) expandable graphite that is a mixture of expandable graphites:
   GR1. A first expandable graphite wherein 75 vol % has a particle size of <150 μm;
   GR2. A second expandable graphite wherein 80 vol % has a particle size of >300 μm; and
   (iii) graphene having a volume average platelet size of from 10 to 30 μm, more preferably 20-30 μm, particularly preferably 24 to 26 μm.
86. Any one preceding embodiment, wherein the at least one polyetherpolyol (b1) comprises a mixture of propylene oxide based diols and triols.
87. Any one preceding embodiment, wherein the at least one polyether polyol in Component B comprises a poly(propylene oxide) triol.
88. Any one preceding embodiment, wherein the at least one polyol in Component B comprises a poly(propylene oxide) triol having an average equivalent weight of 1602.8 g/eq.
89. Any one preceding embodiment, wherein Component B comprises the polyether polyol (b1) at 30 to 45 wt %, more preferably 30 to 40 wt %, particularly preferably 35 to 38 wt %, based on the total weight of Component B.
90. Any one preceding embodiment, wherein Component B comprises at least one poly(propylene oxide) triol at 30 to 45 wt %, more preferably
30 to 40 wt %, particularly preferably 35 to 38 wt %, based on the total weight of Component B.
91. Any one preceding embodiment, wherein Component B comprises a poly(propylene oxide) triol having an average equivalent weight of 1602.8 g/eq at 30 to 45 wt %, more preferably 30 to 40 wt %, particularly preferably 35 to 38 wt %, based on the total weight of Component B.
92. Any one preceding embodiment, wherein Component B comprises a poly(propylene oxide) triol and butane diol.
93. Any one preceding embodiment, wherein Component B comprises 30 to 40 wt % of a poly(propylene oxide) triol, and 4 to 8 wt % butane diol, based on the total weight of Component B.
94. Any one preceding embodiment, wherein the catalysts is selected from tertiary amine catalysts, organometallic catalysts, such as bismuth catalysts, alkyl tin carboxylates, oxides and tin mercaptides.
95. Any one preceding embodiment, wherein the catalyst is dioctyltin mercaptide.
96. Any one preceding embodiment, wherein the catalyst is used at 0.01 to 0.0.02 wt %, more preferably 0.015 wt %, based on the total weight of Component B.
97. Any one preceding embodiment, wherein the thermally conductive filler comprises:
   (i) 75 to 95 wt % aluminium trihydroxide having a multimodal (preferably bimodal) particle size distribution;
   (ii) 5 to 15 wt % expandable graphite, and
   (iii) 0.5 to 4 wt % graphite having an aspect ratio of greater than 3, more preferably greater than 4;
   wherein the wt %'s are based on the total weight of thermally conductive filler.
98. Any one preceding embodiment, wherein the thermally conductive filler comprises:
   (i) 80 to 90 wt % aluminium trihydroxide having a multimodal (preferably bimodal) particle size distribution;
   (ii) 7 to 12 wt % expandable graphite, and
   (iii) 1 to 3 wt % graphite having an aspect ratio of greater than 3, more preferably greater than 4;
   wherein the wt %'s are based on the total weight of thermally conductive filler.
99. Any one preceding embodiment, wherein the thermally conductive filler comprises:
   (i) 85 to 88 wt % aluminium trihydroxide having a multimodal (preferably bimodal) particle size distribution;
   (ii) 9 to 11 wt % expandable graphite, and
   (iii) 1.5 to 2.5 wt % graphite having an aspect ratio of greater than 3, more preferably greater than 4;
   wherein the wt %'s are based on the total weight of thermally conductive filler.
100. Any one preceding embodiment, wherein the thermally conductive filler comprises:
   (i) 75 to 95 wt % aluminium trihydroxide having a multimodal (preferably bimodal) particle size distribution;
   (ii) 5 to 15 wt % expandable graphite, and
   (iii) 0.5 to 4 wt % graphite having an aspect ratio of greater than 2 in the form of particles having a D₉₀ of 80-110 μm, more preferably 85-95 μm;
   wherein the wt %'s are based on the total weight of thermally conductive filler.
101. Any one preceding embodiment, wherein the thermally conductive filler comprises:
   (i) 80 to 90 wt % aluminium trihydroxide having a multimodal (preferably bimodal) particle size distribution;
   (ii) 7 to 12 wt % expandable graphite, and
   (iii) 1 to 3 wt % graphite having an aspect ratio of greater than 2 in the form of particles having a D₉₀ of 80-110 μm, more preferably 85-95 μm;
   wherein the wt %'s are based on the total weight of thermally conductive filler.
102. Any one preceding embodiment, wherein the thermally conductive filler comprises:
   (i) 85 to 88 wt % aluminium trihydroxide having a multimodal (preferably bimodal) particle size distribution;
   (ii) 9 to 11 wt % expandable graphite, and
   (iii) 1.5 to 2.5 wt % graphite having an aspect ratio of greater than 2 in the form of particles having a D₉₀ of 80-110 μm, more preferably 85-95 μm;
   wherein the wt %'s are based on the total weight of thermally conductive filler.
103. Any one preceding embodiment, wherein the adhesive resulting from mixing Component A and Component B comprises:
   (i) 40 to 60 wt % aluminium trihydroxide having a multimodal (preferably bimodal) particle size distribution;
   (ii) 3 to 10 wt % expandable graphite, and
   (iii) 0.5 to 3 wt % graphite having an aspect ratio of greater than 3, more preferably greater than 4;
   based on the total weight of the adhesive.
104. Any one preceding embodiment, wherein the adhesive resulting from mixing Component A and Component B comprises:
   (i) 45 to 55 wt % aluminium trihydroxide having a multimodal (preferably bimodal) particle size distribution;
   (ii) 4 to 7 wt % expandable graphite, and
   (iii) 0.75 to 1.5 wt % graphite having an aspect ratio of greater than 3, more preferably greater than 4;
   based on the total weight of the adhesive.
105. Any one preceding embodiment, wherein the adhesive resulting from mixing Component A and Component B comprises:
   (i) 48 to 50 wt % aluminium trihydroxide having a multimodal (preferably bimodal) particle size distribution;
   (ii) 5.5 to 6.5 wt % expandable graphite, and
   (iii) 1 to 1.3 wt % graphite having an aspect ratio of greater than 3, more preferably greater than 4;
   based on the total weight of the adhesive.
106. Any one preceding embodiment, wherein the adhesive resulting from mixing Component A and Component B comprises:
   (i) 40 to 60 wt % aluminium trihydroxide having a multimodal (preferably bimodal) particle size distribution;
   (ii) 3 to 10 wt % expandable graphite, and
   (iii) 0.5 to 3 wt % graphite having an aspect ratio of greater than 2 in the form of particles having a D₉₀ of 80-110 μm, more preferably 85-95 μm;
   based on the total weight of the adhesive.
107. Any one preceding embodiment, wherein the adhesive resulting from mixing Component A and Component B comprises:
   (i) 45 to 55 wt % aluminium trihydroxide having a multimodal (preferably bimodal) particle size distribution;
   (ii) 4 to 7 wt % expandable graphite, and
   (iii) 0.75 to 1.5 wt % graphite having an aspect ratio of greater than 2 in the form of particles having a D₉₀ of 80-110 μm, more preferably 85-95 μm;
   based on the total weight of the adhesive.
108. Any one preceding embodiment, wherein the adhesive resulting from mixing Component A and Component B comprises:
   (i) 48 to 50 wt % aluminium trihydroxide having a multimodal (preferably bimodal) particle size distribution;
   (ii) 5.5 to 6.5 wt % expandable graphite, and
   (iii) 1 to 1.3 wt % graphite having an aspect ratio of greater than 2 in the form of particles having a D₉₀ of 80-110 μm, more preferably 85-95 μm;
   based on the total weight of the adhesive.
109. Any one preceding embodiment, wherein the thermally conductive filler comprises:
   (i) 75 to 95 wt % aluminium trihydroxide having the following particle size distribution: 1-20 vol %<1 μm, 10-30 vol % 1-10 μm, 5-30 vol. % 10-20 μm, >10 vol % 20-50 μm and >20 vol % 50-100 μm;
   (ii) 5 to 15 wt % expandable graphite, and
   (iii) 0.5 to 4 wt % graphite having an aspect ratio of greater than 3, more preferably greater than 4;
   wherein the wt %'s are based on the total weight of thermally conductive filler.
110. Any one preceding embodiment, wherein the thermally conductive filler comprises:
   (i) 80 to 90 wt % aluminium trihydroxide having the following particle size distribution: 1-20 vol %<1 μm, 10-30 vol % 1-10 μm, 5-30 vol. % 10-20 μm, >10 vol % 20-50 μm and >20 vol % 50-100 μm;
   (ii) 7 to 12 wt % expandable graphite, and
   (iii) 1 to 3 wt % graphite having an aspect ratio of greater than 3, more preferably greater than 4;
   wherein the wt %'s are based on the total weight of thermally conductive filler.
111. Any one preceding embodiment, wherein the thermally conductive filler comprises:
   (i) 85 to 88 wt % aluminium trihydroxide having the following particle size distribution: 1-20 vol %<1 μm, 10-30 vol % 1-10 μm, 5-30 vol. % 10-20 μm, >10 vol % 20-50 μm and >20 vol % 50-100 μm;
   (ii) 9 to 11 wt % expandable graphite, and
   (iii) 1.5 to 2.5 wt % graphite having an aspect ratio of greater than 3, more preferably greater than 4;
   wherein the wt %'s are based on the total weight of thermally conductive filler.
112. Any one preceding embodiment, wherein the thermally conductive filler comprises:
   (i) 75 to 95 wt % aluminium trihydroxide having the following particle size distribution: 1-20 vol %<1 μm, 10-30 vol % 1-10 μm, 5-30 vol. % 10-20 μm, >10 vol % 20-50 μm and >20 vol % 50-100 μm;
   (ii) 5 to 15 wt % expandable graphite, and
   (iii) 0.5 to 4 wt % graphite having an aspect ratio of greater than 2 in the form of particles having a D₉₀ of 80-110 μm, more preferably 85-95 μm;
   wherein the wt %'s are based on the total weight of thermally conductive filler.
113. Any one preceding embodiment, wherein the thermally conductive filler comprises:
   (i) 80 to 90 wt % aluminium trihydroxide having the following particle size distribution: 1-20 vol %<1 μm, 10-30 vol % 1-10 μm, 5-30 vol. % 10-20 μm, >10 vol % 20-50 μm and >20 vol % 50-100 μm;
   (ii) 7 to 12 wt % expandable graphite, and
   (iii) 1 to 3 wt % graphite having an aspect ratio of greater than 2 in the form of particles having a D₉₀ of 80-110 μm, more preferably 85-95 μm;
   wherein the wt %'s are based on the total weight of thermally conductive filler.
114. Any one preceding embodiment, wherein the thermally conductive filler comprises:
   (i) 85 to 88 wt % aluminium trihydroxide having the following particle size distribution: 1-20 vol %<1 μm, 10-30 vol % 1-10 μm, 5-30 vol. % 10-20 μm, >10 vol % 20-50 μm and >20 vol % 50-100 μm;
   (ii) 9 to 11 wt % expandable graphite, and
   (iii) 1.5 to 2.5 wt % graphite having an aspect ratio of greater than 2 in the form of particles having a D₉₀ of 80-110 μm, more preferably 85-95 μm;
   wherein the wt %'s are based on the total weight of thermally conductive filler.
115. Any one preceding embodiment, wherein the adhesive resulting from mixing Component A and Component B comprises:
   (i) 40 to 60 wt % aluminium trihydroxide having the following particle size distribution: 1-20 vol %<1 μm, 10-30 vol % 1-10 μm, 5-30 vol. % 10-20 μm, >10 vol % 20-50 μm and >20 vol % 50-100 μm;
   (ii) 3 to 10 wt % expandable graphite, and
   (iii) 0.5 to 3 wt % graphite having an aspect ratio of greater than 3, more preferably greater than 4;
   based on the total weight of the adhesive.
116. Any one preceding embodiment, wherein the adhesive resulting from mixing Component A and Component B comprises:
   (i) 45 to 55 wt % aluminium trihydroxide having the following particle size distribution: 1-20 vol %<1 μm, 10-30 vol % 1-10 μm, 5-30 vol. % 10-20 μm, >10 vol % 20-50 μm and >20 vol % 50-100 μm;
   (ii) 4 to 7 wt % expandable graphite, and
   (iii) 0.75 to 1.5 wt % graphite having an aspect ratio of greater than 3, more preferably greater than 4;
   based on the total weight of the adhesive.
117. Any one preceding embodiment, wherein the adhesive resulting from mixing Component A and Component B comprises:
   (i) 48 to 50 wt % aluminium trihydroxide having the following particle size distribution: 1-20 vol %<1 μm, 10-30 vol % 1-10 μm, 5-30 vol. % 10-20 μm, >10 vol % 20-50 μm and >20 vol % 50-100 μm;
   (ii) 5.5 to 6.5 wt % expandable graphite, and
   (iii) 1 to 1.3 wt % graphite having an aspect ratio of greater than 3, more preferably greater than 4;
   based on the total weight of the adhesive.
118. Any one preceding embodiment, wherein the thermally conductive filler comprises:
   (i) a mixture of aluminium trihydroxides having the following particle size distributions:
   ATH1. a first aluminium trihydroxide having a particle size distribution as follows:
   D₁₀ 10 μm
   D₅₀ 8 μm
   D₉₀ 100 μm;
   ATH2. a second aluminium trihydroxide having a particle size distribution as follows:
   D₅₀ 8 μm
   D₉₀ 18 μm;
   (ii) expandable graphite that is a mixture of expandable graphites:
   GR1. A first expandable graphite wherein 75 vol % has a particle size of <150 μm;
   GR2. A second expandable graphite wherein 80 vol % has a particle size of >300 μm; and
   (iii) graphite having an aspect ratio of greater than 3, more preferably greater than 4.
119. Any one preceding embodiment, wherein the adhesive resulting from mixing Component A and Component B comprises:
   (i) 40 to 60 wt % aluminium trihydroxide having the following particle size distribution: 1-20 vol %<1 μm, 10-30 vol % 1-10 μm, 5-30 vol. % 10-20 μm, >10 vol % 20-50 μm and >20 vol % 50-100 μm;
   (ii) 3 to 10 wt % expandable graphite, and
   (iii) 0.5 to 3 wt % graphite having an aspect ratio of greater than 2 in the form of particles having a D₉₀ of 80-110 μm, more preferably 85-95 μm;
   based on the total weight of the adhesive.
120. Any one preceding embodiment, wherein the adhesive resulting from mixing Component A and Component B comprises:
   (i) 45 to 55 wt % aluminium trihydroxide having the following particle size distribution: 1-20 vol %<1 μm, 10-30 vol % 1-10 μm, 5-30 vol. % 10-20 μm, >10 vol % 20-50 μm and >20 vol % 50-100 μm;
   (ii) 4 to 7 wt % expandable graphite, and
   (iii) 0.75 to 1.5 wt % graphite having an aspect ratio of greater than 2 in the form of particles having a D₉₀ of 80-110 μm, more preferably 85-95 μm;
   based on the total weight of the adhesive.
121. Any one preceding embodiment, wherein the adhesive resulting from mixing Component A and Component B comprises:
   (i) 48 to 50 wt % aluminium trihydroxide having the following particle size distribution: 1-20 vol %<1 μm, 10-30 vol % 1-10 μm, 5-30 vol. % 10-20 μm, >10 vol % 20-50 μm and >20 vol % 50-100 μm;
   (ii) 5.5 to 6.5 wt % expandable graphite, and
   (iii) 1 to 1.3 wt % graphite having an aspect ratio of greater than 2 in the form of particles having a D₉₀ of 80-110 μm, more preferably 85-95 μm;
   based on the total weight of the adhesive.
122. Any one preceding embodiment, wherein the thermally conductive filler comprises:
   (i) a mixture of aluminium trihydroxides having the following particle size distributions:
   ATH1. a first aluminium trihydroxide having a particle size distribution as follows:
   D₁₀ 10 μm
   D₅₀ 8 μm
   D₉₀ 100 μm;
   ATH2. a second aluminium trihydroxide having a particle size distribution as follows:
   D₅₀ 8 μm
   D₉₀ 18 μm;
   (ii) expandable graphite that is a mixture of expandable graphites:
   GR1. A first expandable graphite wherein 75 vol % has a particle size of <150 μm;
   GR2. A second expandable graphite wherein 80 vol % has a particle size of >300 μm; and
   (iii) graphite having an aspect ratio of greater than 2 in the form of particles having a D₉₀ of 80-110 μm, more preferably 85-95 μm.

### Examples

TABLE 1
List of ingredients used in the Examples

| Trademark or | |
|---|---|
| abbreviation | Chemistry |
| Voranol ™ | a capped polyether triol |
| 4610 | Average equivalent weight 1602.8 g/eq |
| | Molecular weight 4808 g/mol |
| | Hydroxyl number: 33-37 KOH/g, according to ASTM |
| | D4274-94d |
| Jeffamine T403 | polyetheramine characterized by repeating |
| | oxypropylene units in the backbone. As shown by |
| | the structure, JEFFAMINE T-403 is a trifunctional |
| | primary amine having an average molecular weight |
| | of approximately 440. Its amine groups are located |
| | on secondary carbon atoms at the ends of aliphatic |
| | polyether chains. |
| | 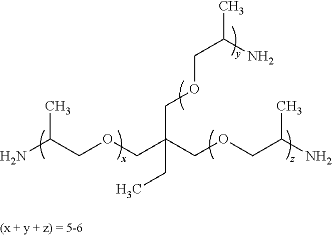 |
| 1,4 butanediol | 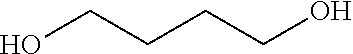 |
| Fomrez UL29 | dioctyltin mercaptide catalyst |
| Polycat SA 1/10 | an acid-free heat activated delayed action |
| | polyurethane catalyst that provides excellent back- |
| | end cure |
| Apyral 1E | Aluminum trihydroxide (ATH) having the following |
| (50 □m) | particle size distribution: |
| | D₁₀ 10 μm |
| | D₅₀ 50 μm |
| | D₉₀ 100 μm |
| Apyral 44 | Aluminum trihydroxide (ATH) having the following |
| (6 □m) | particle size distribution: |
| | D₅₀ 8 μm |
| | D₉₀ 19 μm |
| Apyral 60D | Aluminum trihydroxide (ATH) having the following |
| (1 □m) | particle size distribution: |
| | D₁₀ 0.6 μm |
| | D₅₀ 1.5 μm |
| | D₉₀ 2.7 μm |
| ES 100 C10 | Expandable graphite |
| | Carbon content: mon. 92%, expansion in cm³/g: |
| | 100, particle size: 75% <150 μm |
| ES 250 B5 | Expandable graphite |
| | Carbon content: min. 90%, expansion in cm³/g: 250, |
| | particle size: 80% >300 μm |
| graphene | Surface area: 30-60 m²/g |
| xGnP-R25 | Thickness: 16-20 nm |
| | Density: 2.2 g/cm³ |
| | Average platelet size: 25 μm |
| TIMREX | Graphite with aspect ratio >2, D₉₀ = 90 μm |
| C-therm 011 | |
| molecular sieve | |
| Isonate ™ | Low viscosity, modified diphenylmethane |
| M143 | diisocyanate containing a high percentage of pure |
| | diphenylmethane diisocyanate, and a lesser amount |
| | of polycarbodiimide adducts, having an isocyanate |
| | functionality of about 2.2, and a molecular weight of |
| | 315 g/mol. |
| Isonate M342 | liquid, modified diphenylmethane diisocyanate (MDI) |
| | with an average functionality of 2.0, and a molecular |
| | weight of 360 g/mol. |
| Voranate ™ | low viscosity polymethylene polyphenylisocyanate of |
| 220M | high reactivity, a total isocyanate content of about |
| | 31% and an average functionality of 2.7 and an |
| | average molecular weight of 367 g/mol. |
| Voranol ™ | a polypropylene glycol, propyleneglycol initiated, |
| 1010L | 1000 molecular weight homopolymer diol. |
| | Average equivalent weight: 512.3 g/eq |
| | Average OH number: 109 KOH/g |
| | Molecular weight: 1024 g/mol |
| Voranol ™ | a polypropylene glycol, propyleneglycol initiated, |
| 2000L | 2000 molecular weight homopolymer diol. |
| | Average equivalent weight: 1001.7 g/eq |
| | Average OH number: 56 KOH/g |
| | Molecular weight: 2003 g/mol |
| Voranol ™ | A glycerine-initiated ethylene oxide capped |
| 4610 | polypropylene oxide polyether triol with a molecular |
| | weight of 4,800 Da |
| Vorapel ™ | A low viscosity hydrophobic (polybutyleneoxide)diol, |
| D3201 | with: |
| | Average equivalent weight: 1001.7 g/eq |
| | Average OH number: 56 KOH/g |
| | Molecular weight: 2003 g/mol |
| | Nominal functionality: 2 |
| Voranol ™ | a polypropylene glycol, propyleneglycol initiated, 400 |
| P400 | molecular weight homopolymer diol. |
| | Average equivalent weight: 215.7 g/eq |
| | Average OH number: 260 KOH/g |
| | Molecular weight: 431 g/mol |
| | Nominal functionality: 2 |
| Vestinol 9 | Di-isononyl phthalate |

### Formulation of Adhesives

Component A (isocyanate) and Component B (polyol) were prepared in a 4-5 L planetary mixer laboratory scale mixer. Using the ingredients listed in Table 2.

To prepare Component B (polyol), the ingredients listed in Table 2 were blended to homogeneity in a planetary mixer.

To prepare Component A (isocyanate), an isocyanate-terminated prepolymer was prepared by first mixing the polyol ingredients of Component A (diols and/or triols). The isocyanate ingredients were then added with stirring at ambient temperature. The filler ingredients were then added and the mixture was heated to 40° C. and stirred for 45 minutes until the mixture was clear. The mixture was then heated to 70° C. over 30 minutes. A vacuum of 80 mbar was applied, and mixing was continued for an additional 60 minutes. Heating was discontinued, and the mixture was stirred under vacuum until a temperature of 40° C. was reached. The vacuum was broken under nitrogen, and Component A was stored in foil packaging under nitrogen until use.

Components A and B were stored separately until use. The components were then mixed in a 1:1 volumetric ratio. The resulting adhesive was cured for seven days at 23° C. and the properties were measured.

### Test Methods

### Thermal Conductivity

Thermal conductivity was measured according to ASTM 5470. A thermal interface material tester from ZFW Stuttgart was used for the test. The measurement was performed in Spaltplus mode between 1.8-1.2 mm thickness. The absolute thermal conductivity A (W/mK) is reported.

### Elongation at Break

Elongation at break was measured according to DIN 527-1.

### Lap Shear Strength

Lap shear strength was measured according to DIN 1465. The samples were e-coated substrates having dimensions of 25 mm×12.5 mm×0.5 mm, and adhesion area of 25 mm×20 mm and an adhesive thickness of 0.5 mm. The adhesive was cured for seven days at 23° C. Lap shear strength was also evaluated after exposure for seven days at 70° C. and 100% relative humidity (RH).

TABLE 2
Ingredients in Inventive and Comparative adhesives and key properties
of adhesive resulting from 1:1 volumetric mixture

| Component B | | | | | |
|---|---|---|---|---|---|
| (polyol) | inventive 1 | inventive 5 | comparative 2 | comparative 3 | comparative 4 |
| Voranol ™ 4610 | 36.7 | 30.485 | 31.5 | 28.39 | 35 |
| Jeffamine T403 | 0 | 0 | 0.05 | 0 | 0 |
| 1,4-butanediol | 6 | 6 | 4.5 | 4.5 | 0.78 |
| Fomrez UL29 | 0.015 | 0.015 | 0.015 | 0.015 | 0.015 |
| Polycat SA 1/10 | 0.05 | 0.05 | 0.05 | 0.05 | 0.05 |
| Apyral 1E (50 □m) | 43 | 43 | 35 | 49 | 0 |
| Apyral 44 (6 □m) | 6 | 9 | 14 | 10 | 32 |
| Apyral 60E (1 □m) | 0 | 0 | 9 | 0 | 32 |
| ES 100 C10 | 3 | 3.75 | 5 | 0 | 0 |
| ES 250 B5 | 3 | 3 | 0 | 6 | 0 |
| graphene xGnP- | 1.2 | 0 | 0 | 2 | 0 |
| R25 | | | | | |
| Timrex C-therm | 0 | 1.2 | | | |
| 011 | | | | | |
| molecular sieve | 1 | 1 | 1 | 1 | 1 |
| Component A | | | | | |
| (isocyanate) | inventive 1 | Inventive 5 | comparative 2 | comparative 3 | comparative 4 |
| Isonate ™ M143 | 27 | 27.5 | 0 | 0 | 6.5 |
| Isonate M342 | 0 | 0 | 29.15 | 29.15 | 0 |
| Voranate ™ 220M | 5 | 5.5 | 0 | 0 | 0 |
| Voranol ™ 1010L | 8 | 8 | 0 | 0 | 0 |
| Voranol ™ 2000L | 0 | 0 | 0 | 0 | 9.7 |
| Voranol ™ 4610 | 0 | 0 | 13.2 | 10.56 | 16.38 |
| Vorapel ™ D3201 | 0 | 0 | 7.75 | 6.2 | 0 |
| Voranol ™ P400 | 3 | 3 | 0 | 0 | 0 |
| Vestinol 9 | 0 | 0 | 8.1 | 8.1 | 17.52 |
| Apyral 1E (50 □m) | 42.8 | 41.8 | 22 | 34 | 0 |
| Apyral 44 (6 □m) | 7 | 7 | 11 | 4 | 37.5 |
| Apyral 60E (1 □m) | 0 | 0 | 6.5 | 0 | 12.5 |
| ES 100 C10 | 4.5 | 4.56 | 3 | 0 | 0 |
| ES 250 B5 | 1.5 | 1.4 | 0 | 6 | 0 |
| graphene xGnP- | 1.2 | 0 | 0 | 2 | 0 |
| R25 | | | | | |
| Timrex C-therm | 0 | 1.2 | | | |
| 011 | | | | | |
| Hard segment | 32 | | 29.15 | 29.15 | 6.5 |
| content (wt %) | | | | | |
| NCO functionality | 2.22 | | 2.20 | 2.17 | 2.13 |
| of prepolymer | | | | | |

| | | | | | |
|---|---|---|---|---|---|
| KEY | | | | | |
| PROPERTIES | inventive 1 | Inventive 5 | Comparative 2 | Comparative 3 | Comparative 4 |

| | | | | | | | | | |
|---|---|---|---|---|---|---|---|---|---|
| thermal | 1.2 | W/mK | 1.2 | 0.7 | W/mK | 1.3 | W/mK | 0.6 | W/mK |

| | | | | | |
|---|---|---|---|---|---|
| conductivity | | | | | |
| [W/mK] | | | | | |
| elongation at | 15% | — | 40% | 10% | 260% |
| break [%] | | | | | |

| | | | | | | | | | |
|---|---|---|---|---|---|---|---|---|---|
| shear strength 7 d | 5.1 | MPa | — | 5.5 | MPa | 3.3 | MPa | 2.7 | MPa |

| | | | | | |
|---|---|---|---|---|---|
| RT | | | | | |
| shear strength 7 d | 3.6 MPa | — | 4.3 MPa | 1.3 MPa | 2.2 MPa |
| 70° C., 100% a.h. | (70%) | | (78%) | (40%) | (80%) |

### Results

Inventive Example 1 achieves good thermal conductivity of 1.2 W/mK, as well as good lap shear strength, and excellent retention of lap shear strength after exposure to heat and humidity. Of the Comparative Examples, the only one that shows acceptable thermal conductivity is Comparative Example 3, however, the lap shear strength is compromised, and retention of lap shear strength after exposure to heat and humidity is unacceptable.

1. A thermally-conductive, two-component polyurethane adhesive comprising:
(A) a first component (isocyanate component), comprising:
(a1) at least one polyisocyanate;
(B) a second component (polyol component), comprising:
(b1) at least one polyetherpolyol; and
(b2) at least one catalyst capable of catalyzing the reaction of a hydroxyl group with an isocyanate group;
wherein Component A and/or Component B comprise (a2, b3) thermally conductive filler which comprises:
(i) aluminium trihydroxide having a multimodal particle size distribution;
(ii) expandable graphite, and
(iii) graphene, and/or graphite having an aspect ratio greater than 2;
and wherein the concentration of thermally conductive filler in Component A and/or Component B is sufficient to yield a concentration of 40 to 80 wt % thermally conductive filler in the adhesive when Component A and Component B are mixed together to form the adhesive.

2. The adhesive of claim 1, wherein the at least one polyisocyanate has an average NCO functionality of greater than 2.

3. The adhesive of claim 1, wherein the at least one polyisocyanate has an average NCO functionality of greater than 2.1.

4. The adhesive of claim 1, wherein the at least one polyisocyanate has an average NCO functionality of greater than 2.15.

5. The adhesive of claim 1, wherein the at least on polyisocyanate is a prepolymer which is formed by reaction of at least one molecule bearing two or more isocyanate groups with a polyol, such that the terminal groups are isocyanate groups.

6. The adhesive of claim 1, wherein the polyisocyanate is a prepolymer which is formed by reaction of at least one molecule bearing two or more isocyanate groups with a polyether polyol, such that the terminal groups are isocyanate groups.

7. The adhesive of claim 1, wherein the polyisocyanate is a prepolymer which is formed by reaction of at least one molecule bearing two or more isocyanate groups, having an average NCO functionality of greater than 2, more preferably 2.1 or greater, more particularly preferably 2.15 or greater, with a polyether polyol, such that the terminal groups are isocyanate groups.

8. The adhesive of claim 1, wherein the polyisocyanate is a prepolymer which is formed by reaction of at least one molecule bearing two or more isocyanate groups with a poly(propylene oxide)-based polyol, such that the terminal groups are isocyanate groups.

9. The adhesive of claim 1, wherein the polyisocyanate is a prepolymer which is formed by reaction of at least one molecule bearing two or more isocyanate groups with a poly(propylene oxide)-based diol, such that the terminal groups are isocyanate groups.

10. The adhesive of claim 1, wherein the polyisocyanate is a prepolymer formed by reaction MDI with a polyether polyol.

11. The adhesive of claim 1, wherein the polyisocyanate is a prepolymer formed by reaction MDI with a poly(propylene oxide)-based polyol.

12. The adhesive of claim 1, wherein the polyisocyanate is a prepolymer formed by reaction MDI with a poly(propylene oxide)-based diol.

13. The adhesive of claim 1, wherein the polyisocyanate is a prepolymer formed by reaction MDI with a first poly(propylene oxide)-based diol having an equivalent weight of 700 g/eq or greater and a second poly(propylene oxide)-based diol having an equivalent weight of 500 g/eq or less.

14. The adhesive of claim 1, wherein the polyisocyanate is a prepolymer formed by reaction MDI with a first poly(propylene oxide)-based diol having an equivalent weight of 1001 g/eq and a second poly(propylene oxide)-based diol having an equivalent weight of 215 g/eq.

15. The adhesive of claim 1, wherein the polyisocyanate is a prepolymer having an average NCO functionality of greater than 2.0, more preferably 2.1 or greater.
